(19) United States
(12) Patent Application Publication
(10) Pub. No.: US 2018/0181906 A1
(43) Pub. Date: Jun. 28, 2018

(54) STOCK MANAGEMENT APPARATUS, METHOD AND SYSTEM

(71) Applicant: PANASONIC INTELLECTUAL PROPERTY MANAGEMENT CO., LTD., Osaka (JP)

(72) Inventors: Thilmee Malinda BADUGE, Tokyo (JP); Howard HUANG, Bayside, NY (US); Yukinaga SEKI, Kyoto (JP); Shutai OKAMURA, Osaka (JP); Ryuuichi YATSUNAMI, Fukuoka (JP); Yuji ABE, Kanagawa (JP); Yohei KUSHIDO, Kanagawa (JP); Die LIU, Kanagawa (JP); Atsushi MOHRI, Kanagawa (JP)

(73) Assignee: PANASONIC INTELLECTUAL PROPERTY MANAGEMENT CO., LTD., Osaka (JP)

(21) Appl. No.: 15/736,665

(22) PCT Filed: Jun. 17, 2016
(86) PCT No.: PCT/US2016/038054

§ 371 Date: Dec. 14, 2017

Related U.S. Application Data
(60) Provisional application No. 62/310,261, filed on Mar. 18, 2016.
(60) Provisional application No. 62/180,882, filed on Jun. 17, 2015.

(51) Int. Cl. G06Q 10/08; G06K 7/10

(52) U.S. Cl. CPC G06Q 10/087; G06K 7/10366

(57) ABSTRACT

A method includes detecting status of stock displayed on stocking place like a shelf, and transmitting information based on the status of stock to deliverer having the stock a predefined receiver.

### CROSS-REFERENCE TO RELATED APPLICATION

This application claims the benefit of U.S. Provisional Patent Application No. 62/180,882, filed on Jun. 17, 2015 and U.S. Provisional Patent Application No. 62/310,261 filed on Mar. 18, 2016, the disclosures of which are incorporated by reference herein in their entirety.

### BACKGROUND OF THE INVENTION

### 1. Field of the Invention

The present disclosure relates to a stock management apparatus for notifying a deliverer of stock status.

### 2. Description of Related Art

It is not easy for delivery personnel to check stock status of stockable items such as food or drinks in a store on a daily basis, the delivery personnel including a manufacturer (e.g. food or drink maker), a delivery company hired by the manufacturer or the retail store, or the like. Accordingly some foods or drinks disappeared from shelves completely sometimes. When the foods or drinks got sold out in this manner, the retail store or the manufacturer lost opportunities to sell their products.

### SUMMARY OF THE INVENTION

Therein a stock management system is provided with a retail store, the delivery personnel which is a supplier to the retail store. The stock management system includes stock detectors which are placed in the retail store, especially around the stockable items (e.g. on/in shelves or on/in refrigerator). Then the stock detectors send the detected result to a management device which is connected to each stock detector. The central controller may be connected to a network (like WAN or LAN), further may transmits stock results received from the stock detectors to a server via the network. The server manages the stock results received from a plurality of management devices, then these stock results are stored in the server as a stock status. Some computers owned by the retail store, the delivery personnel or a server manager can access the stock status. As a result the stock status can be seen even if nobody checks the stock status at the retail store.

Further the server may output an alert to the delivery personnel in order to remind them to restock the stockable items when some conditions are satisfied. These conditions can be arranged by a user, that is, a member of the delivery personnel by using a computer which may be able to access to the server to see the stock status.

Many kinds of devices may be used as the stock detector. For instance, a RFID, a camera performing image processing, weight sensor, a sheet-shaped sensor with membrane switch.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a stock management system in accordance with a feature of the disclosure;

FIG. 2 is a flow chart of detecting system accordance with a feature of the disclosure;

FIG. 3 is a block diagram of detecting system in accordance with a feature of the disclosure;

FIG. 4 is a block diagram of detecting terminals in accordance with a feature of the disclosure;

FIG. 5 is a detecting system in a retail store in accordance with a feature of the disclosure;

FIG. 6 is a stock management system in accordance with a feature of the disclosure;

FIG. 7 is an alert message in accordance with a feature of the disclosure;

FIG. 8 is a flow chart of a stock management server in accordance with a feature of the disclosure;

FIG. 9 is an example of setting conditions for alerting in accordance with a feature of the disclosure;

FIG. 10 is an example of a planogram in accordance with a feature of the disclosure;

FIG. 11 is a flowchart for changing a planogram in accordance with a feature of the disclosure;

FIG. 12 is an example of images displaying planograms in accordance with a feature of the disclosure;

FIG. 13 is a shelf with displays in a retail store in accordance with a feature of the disclosure;

FIG. 14 is a flowchart for changing a display attached to a shelf in accordance with a feature of the disclosure;

FIG. 15 is a flow chart of a management device in accordance with a feature of the disclosure;

FIG. 16 is a flow chart of a management device in accordance with a feature of the disclosure;

FIG. 17 is each view of a shelf with wireless readers and tags in accordance with a feature of the disclosure;

FIG. 18 is each view of a shelf with wireless readers and tags in accordance with a feature of the disclosure;

FIG. 19 is each view of a shelf with wireless readers and tags in accordance with a feature of the disclosure;

FIG. 20 is each view of a shelf with wireless readers and tags in accordance with a feature of the disclosure;

FIG. 21 is each view of a shelf with wireless readers and tags in accordance with a feature of the disclosure;

FIG. 22 is each view of a shelf with wireless readers and tags in accordance with a feature of the disclosure;

FIG. 23 is each view of a shelf with wireless readers and tags in accordance with a feature of the disclosure;

FIG. 24 is each view of a shelf with wireless readers and tags in accordance with a feature of the disclosure;

FIG. 25 is each view of a shelf with wireless readers and tags in accordance with a feature of the disclosure;

FIG. 26 is each view of a shelf with wireless readers and tags in accordance with a feature of the disclosure;

FIG. 27 is a table showing stock status in accordance with a feature of the disclosure;

FIG. 28 is a table showing stock status in accordance with a feature of the disclosure;

FIG. 29 is a table showing stock status in accordance with a feature of the disclosure;

FIG. 30 is a displayed image on device of a deliverer in accordance with a feature of the disclosure;

FIG. 31 is an explanatory diagram showing notifications to drivers in accordance with a feature of the disclosure;

FIG. 32 is a flow chart of a deliverer in accordance with a feature of the disclosure;

FIG. 33 is a detection sheet in accordance with a feature of the disclosure;

FIG. 34 is a detection sheet in accordance with a feature of the disclosure;

FIG. 35 is a detection sheet in accordance with a feature of the disclosure;

FIG. 36 is a detection sheet in accordance with a feature of the disclosure;

FIG. 37 is a flowchart of a detecting system in accordance with a feature of the disclosure;

FIG. 38 is one example of a detecting system in accordance with a feature of the disclosure;

FIG. 39 is one example of a detecting system in accordance with a feature of the disclosure;

FIG. 40 is an image including planogram and stock status in accordance with a feature of the disclosure;

FIG. 41 is data list stored in the database in accordance with a feature of the disclosure;

FIG. 42 is stock statuses in an area including a plurality of stores in accordance with a feature of the disclosure;

FIG. 43 is stock statues at a store including a plurality of store shelves in accordance with a feature of the disclosure; and

FIG. 44 is stock statuses in one shelf in accordance with a feature of the disclosure.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

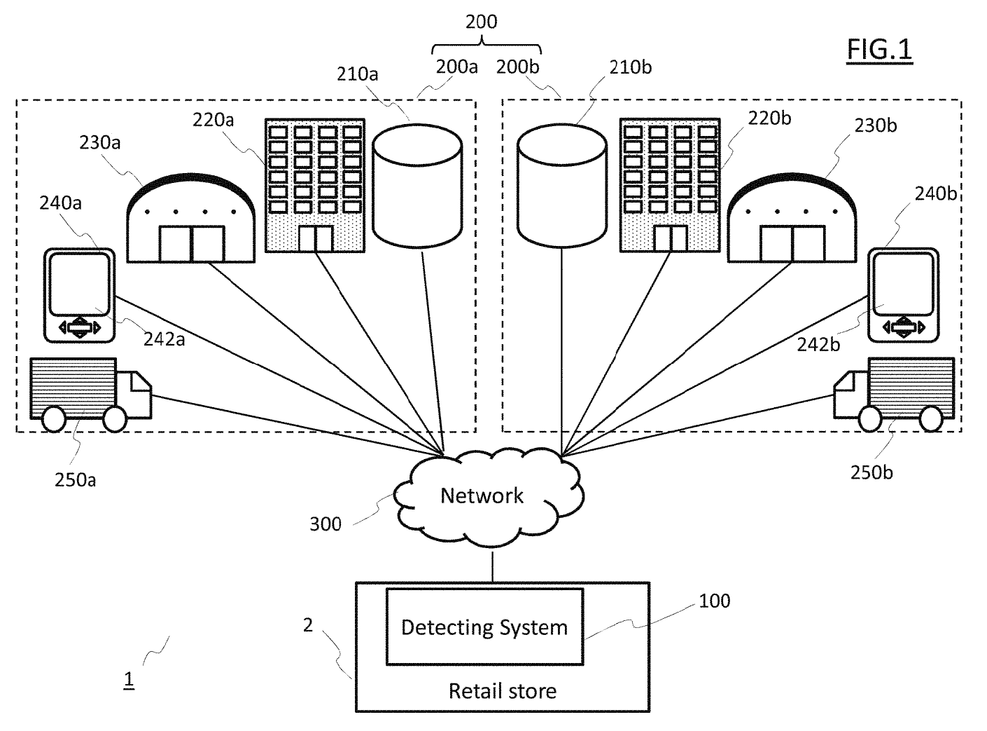

Referring to the drawings wherein like characters represent like elements, FIG. 1 is a stock management system 1 in accordance with a feature of the disclosure. The stock management system 1 have a detecting system 100 and a deliverer 200 connected to the detecting system 100 through the network 300. The detecting system 100 is installed in a retail store 2 and communicates to the deliverer 200 through the network 300. The deliverer 200 deliveries foods or drinks to the retail stores 2. Detecting system 100 detects stock status (e.g. the number of products on a shelf) of each food or drink in the retail store 2. Then the detecting system 100 transmits stock information, including alert, table or chart, based on the stock status detected by the detecting system 100 through the network 300. Thus deliverer can recognize the stock status upon receiving the stock information. The stock management system 1 may have a plurality of the detecting systems 100, each of which is installed in different retail stores 2 and transmits the stock information to the deliverer 200.

The deliverer 200 receives the stock information from the detecting system 100. The deliverer 200, for instance, corresponds to manufacturer 200a or a delivery company 200b. The manufacturer 200a distributed their products (e.g. foods or drinks) to the retail stores 2. The products are displayed on shelves in the retail store 2 and bought by customers visiting the retail store 2. Thus, it is better for the manufacturer 200a and the retail store 2 to be displayed the products on the shelves at all times during opening hours of the retail store 2 in order to maintain sales opportunities.

Although it depends on business of between the retail store 2 and the manufacturer 200a, the manufacturer 200a displays their products in the retail store 2 by themselves in one of the business between them. In other words, a member of the manufacturer 200a visits the retail store 2, then displays and restocks the products or replaces new products on the shelves. However an employee or the representative of the manufacturer 200a does not basically work at the retail store 2 in general because the retail store 2 and the manufacturer 200a are different companies and have infrequent locations. Thus the detecting system 100 transmits the stock information to the manufacturer 200a for noticing the stock status. In other words the stock information is transmitted to at least one of devices or facilities, belonging to the manufacturer 200a, including at least one of a server 210a, an office 230a, mobile terminal 240a with a display 242a or a distribution vehicle 250a through the network 300. As a result, the manufacturer 200a can remotely determine whether they should deliver their products to the retail store 2 today or in a few days.

The server 210a is managed by the manufacturer 200a and stores several data related to the manufacturer 200a. The office 220a is a work place for members of the manufacturer 200a. Also, devices (e.g. desktop computers, laptop computers, mobile terminals, or the like) in the office 220a receive the stock information from the detecting system 100. The warehouse 230a houses or stores the products produced by the manufacturer 200a. Also, devices (e.g. desktop computers, laptop computers, mobile terminals, or the like) in the warehouse 230a receive the stock information from the detecting system 100. The mobile terminal 240a may be owned by the manufacturer 200a and assigned to a member of the manufacturer 200a. The mobile terminal 240 may display the stock information on the display 242a upon receiving it. Also, the mobile terminal 240 may be owned personally by a member of the manufacturer 200a. The distribution vehicle 250a (e.g. truck) is used to deliver the products of the manufacturer 200a to the retail store 2. Devices (e.g. mobile terminal powered by a battery or the distribution vehicle 250a) receive the stock information through the network 300. Further one of the server 210a, devices in the office 220a or the warehouse 230a, the mobile terminal 240a, the distribution vehicle 250a may transmit the stock information to another one of them upon receiving the stock information. For example, the server 210a transmits the stock information or arranged information based on the stock information to the mobile terminal 240a through the network 300.

In the same manner, the delivery company 200b may receive the stock information as the deliverer 200. In one of embodiments, the delivery company 200b receives a job offer for delivering the products to the retail store 2 from the manufacturer 200a through the network 300. In other words, the delivery company 200b delivers the products of the manufacturer 200a in response to orders or commands from the manufacturer 200a. In another one of embodiments, the delivery company 200b receives a job offer delivering the products to the retail store 2 from the retail store 2 through the network 300. In other words, the delivery company 200b delivers the products of the manufacturer 200a in response to orders or commands from the retail store 2.

The delivery company 200b has at least one of a server 210b, an office 220b, a warehouse 230b, mobile terminal 240b with a display 242b or a distribution vehicle 250b similar to the manufacturer 200a.

Further, the detecting system 100 may transmit the stock information to both the manufacturer 200a and the delivery company 200b. Alternatively the detecting system 100 may select a destination of stock information of each product in accordance with a brand or a maker of each product.

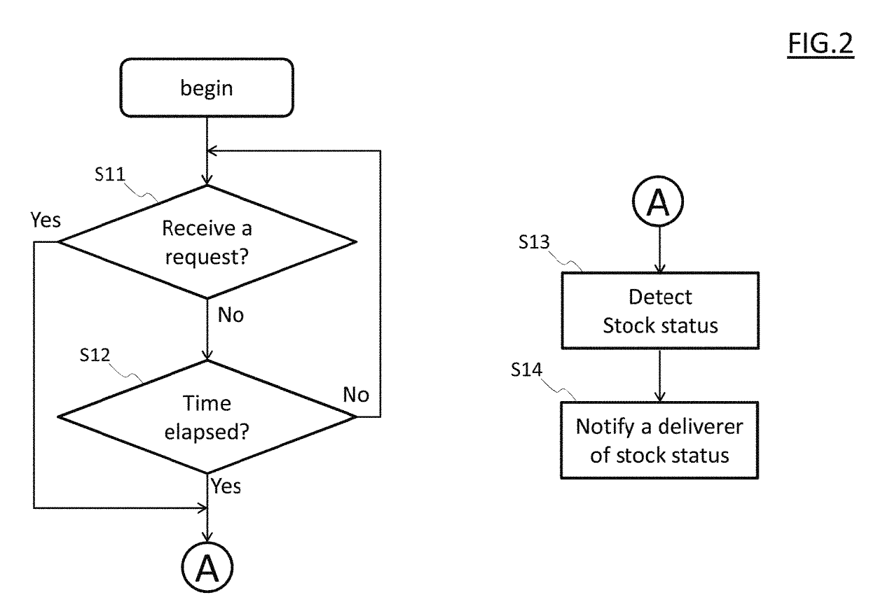

FIG. 2 is a flow chart of the detecting system 100 in accordance with a feature of the disclosure. As shown in FIG. 2, when the detecting system 100 receives a request from the deliverer 200 (Step S11), detects the stock status (Step S13) and notifies the deliverer 200 of the stock status (Step S14). Or, when the detecting system 100 does not receive (Step S11), but elapses the predetermined time (Step S12), detects the stock status (Step S13) and notifies the deliverer 200 of the stock status (Step S14). In contrast, if the request is not transmitted to the detecting system 100 (Step S11) and the predetermined time is not elapsed (Step S12), the detecting system does not detect the stock status or transmit it to the deliverer 200.

The predetermined time can be changed arbitrarily in response to an input received from a user or an operator. For instance, the detecting system 100 may detect the stock status and transmit the stock information based on the stock status every hour or at the same hour every day.

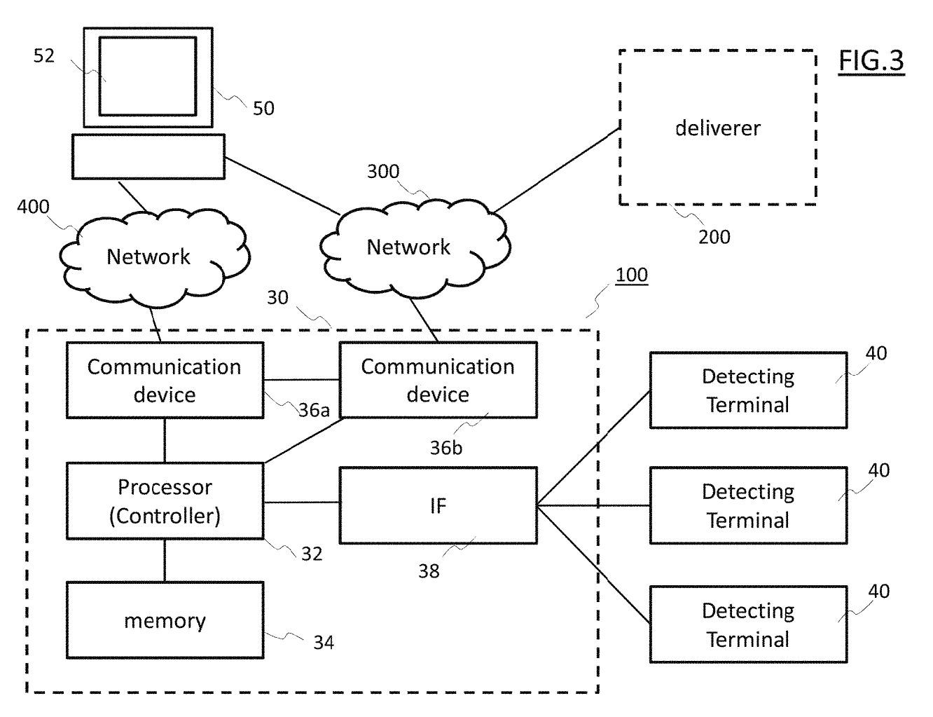

FIG. 3 is a block diagram of the detecting system 100 in accordance with a feature of the disclosure. The detecting system 100 has a management device 30, a plurality of detecting terminals 40, and a computer 50 with a display 52. The management device determines the stock status based on a detected result of each of the detector 40. The management device 30 is connected to each of the detecting terminal 40 through a (wired) communication line. Or, the management device 30 may conduct wireless communication into the detecting terminals 40. Also, the management device 30 can directly communicate to the deliverer 200 through the network 300 (e.g. wide area network). The management device 30 can communicate to the computer 50 through the network 400 (e.g. local area network).

The management device 30 further has processor (controller) 32, memory 34, communication device 36a and 36b, and IF (interface) 38. The processor 32 controls the management device 30 to detect the stock status and transmit stock information. The processor 32 receives detected results of detecting terminals 40 through the IF 38 and compares the results with information stored in the memory 34. Further, the processor 32 calculates the stock status in accordance with processes of the comparisons. In addition, the processor 32 generates the stock information based on the stock status of each of the detecting terminal 40, after that, the communication device 36a transmits it to the deliverer 200 through the network 300 or the communication device 36a transmits the computer 50 through the network 400. The network 400 may have Wi-Fi network or wired network installed in the retail store 2. In one of embodiments, the Wi-Fi network may correspond to free Wi-Fi network geared toward customers of the retail store 2. In another one of embodiments, the Wi-Fi network may correspond to locked Wi-Fi network for staffs or devices of the staffs.

The computer 50 may be positioned and installed in an office room being different space from a sales floor in the retail store 2. The office room may correspond to one of rooms in the retail store 2, the office 220a, 220b the warehouse 230a or 230b. When the computer 50 receives the stock status or the stock information from the management device 30 through the network 400, displays it on the display 52 and forwards it to the deliverer 200 through the network 300. In addition, if the computer 50 is connected to a plurality of the management device 30 through the network 400, the computer 50 generates the stock information based on the stock status received from the plurality of the management devices 30.

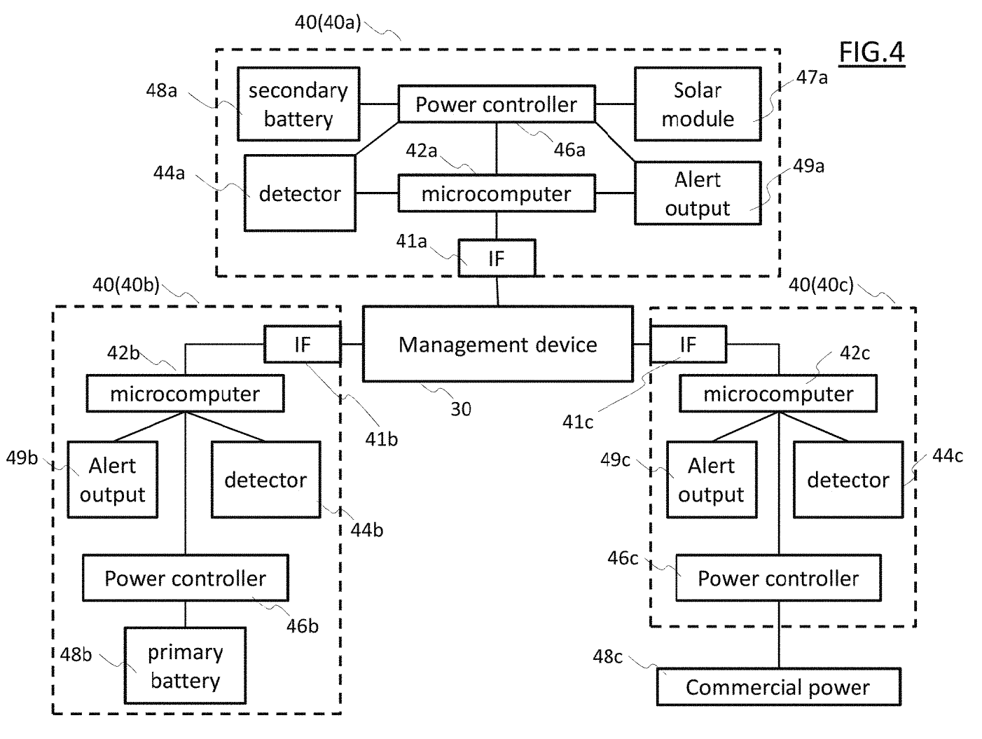

FIG. 4 is a block diagram of detecting terminals 40 in accordance with a feature of the disclosure. Detecting terminals 40, including a detecting terminal 40a, 40b and 40c, are controlled by the management device 30. As shown FIG. 4, the management device 30 is connected to detecting terminals 40 having different structures or functions. But the management device 30 can be connected to detecting terminals 40 having the same structures of functions inherently.

The detecting terminal 40a has an IF 41a, a microcomputer 42a, a detector 44a, a power controller 46a, a solar module 47a, a secondary battery 48a and an alert output 49a.

The microcomputer 42a has programs to control the detecting terminal 40a in response to a command or request received from the management device 30 through the IF 41a. The detector 44a detects the stock status when instructed from the microcomputer 42a. The microcomputer 42a and detector 44a are driven by the solar module 47a or the secondary battery 48a. The power controller 46a switches a power source of the detecting terminal to either the secondary battery or the solar module 47a in accordance with a remaining power level of the secondary battery 48a. For instance, when the remaining power level of the secondary battery 48a is less than a predetermined level, the microcomputer 42a and the detector 44a are supplied from the solar module 47a. On the other hand, when the remaining power level of the secondary battery 48a is equal to or greater than a predetermined level, power generated by the solar module 47a, having a plurality of solar cells, is charged to the secondary battery 48a.

The detecting terminal 40b has an IF 41b, microcomputer 42b, detector 44b, power controller 46b, primary battery 48b and alert output 49b.

The microcomputer 42b has programs to control the detecting terminal 40b in response to a command or request received from the management device 30 through the IF 41b. The detector 44b detects the stock status when instructed from the microcomputer 42b. The microcomputer 42b and detector 44b are driven by the primary battery 48b. The power controller 46b observes a power remaining level of the primary battery 48b. When the power remaining level of the primary battery 48b is less than a predetermined level, the microcomputer 42b controls the alert output 49b to output an alert, further transmits a request for replacing the primary battery to the deliverer 200. Accordingly the deliverer can find the detecting terminal 40b with a dead or depleted battery.

The detecting terminal 40c has an IF 41c, microcomputer 42c, detector 44c, power controller 46c. The microcomputer 42c has programs to control the detecting terminal 40c in response to a command or request received from the management device 30 through the IF 41c. The detector 44c detects the stock status when instructed from the microcomputer 42c. The microcomputer 42c and detector 44c are driven by the power controller 46c. The power controller generates power for the microcomputer 42c and the detector 44c upon receiving power from a commercial power 48c.

Alert output 49a, 49b and 49c may has a speaker outputting sounds and/or display (e.g. LED) outputting or flashing lights. The management device 30 determines that the detecting terminal 40 does not work if the management device 30 does not receive the detected result for a while. Then the management device 30 request the alert 49a, 49b, or 49c in the non-responded detecting terminal 40 to output their alerts.

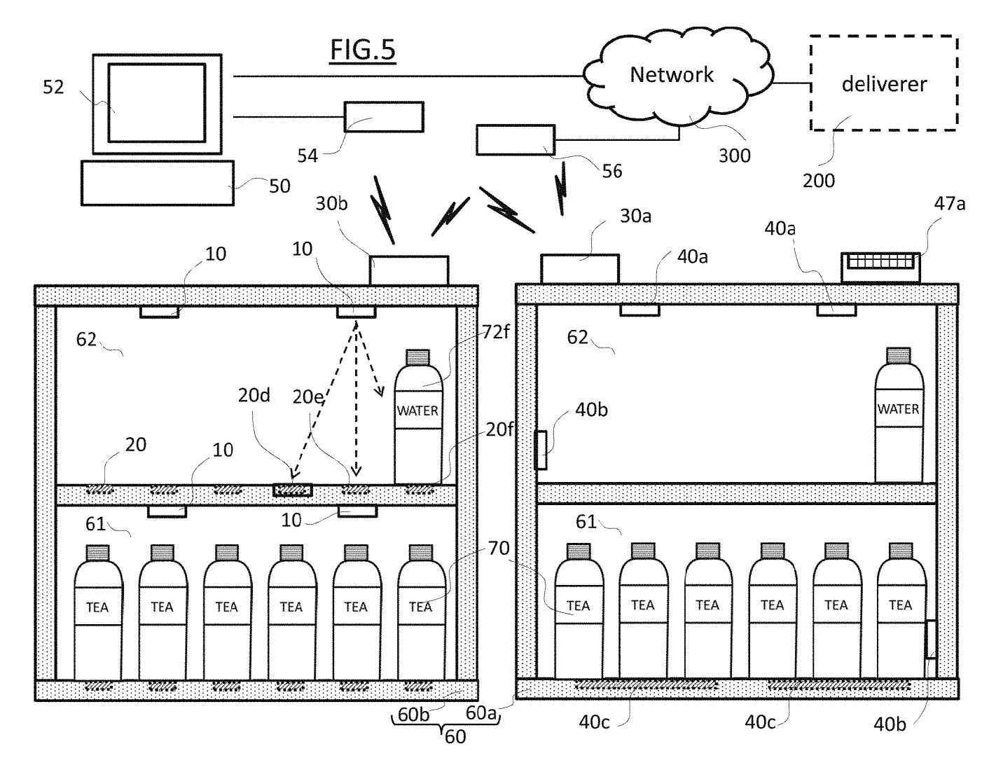

FIG. 5 is the detecting system 100 in the retail store 2 in accordance with a feature of the disclosure. There are a plurality of shelves 60, including a shelf 60a and 60b, in the retail store 2. Each of the shelf 60 is displayed a plurality of bottles 70 including water bottle 72f. The shelf 60 has a plurality of racks including a first racks 61 and a second rack 62 on the first rack 61. As shown FIG. 5, at least six bottles 70 are on the first rack 61 and one bottle 70 (the water bottle 72f) is on the second rack 62. The first rack 61 and the second rack 62 are provided with four surfaces. Two of the four surfaces face each other. Also, the other two of four surfaces face each other. The shelf 60b is also configured similar to the shelf 60a.

A communication device 54 can communicate to the management device 30a and/or 30b through the wireless network (e.g. network 400). A communication device 56 can communicate to the management device 30a and/or 30b through the wireless network (e.g. network 400).

The detecting terminal 40a is arranged on an upper surface of the second rack 62 of the shelf 60a. Thus the detecting terminal 40a is easily connected to the solar module 47a arranged on a top of the shelf 60a. The detecting terminal 40a is attached on the same board together with the solar module 47a, but positioned on an opposite surface of the board of the solar module 47a. The solar module 47a may be installed on the top of the shelf 60a for receiving a lot of shine from the sun or overheads of the retail store 2 and generating a lot of power.

The detecting terminal 40b is installed on a side surface of the second rack 62 of the shelf 60a. The detecting terminal 40b can be moved to anywhere because it does not need to consider the power source.

The detecting terminal 40c is arranged on a lower surface of the first rack 61 of the shelf 60a. Thus the detecting terminal 40c is positioned under the plurality of the bottles 70. The detecting terminal 40c also may be implanted in a bottom board of the shelf 60a. The detecting terminal 40c, positioned near the ground, can easily be connected to the commercial power 48c because outlets of the commercial power 48a are installed at a position near the ground in many cases.

The detector 44 (including the detector 44a, 44b or 44c) can be a camera taking a picture. In that case, the picture, took by the camera, is transmitted to the management device 30a or 30b as the stock status. Or the camera may conduct an image processing to obtain the stock status (e.g. the number of the bottles 70 on the shelf 60a). In case of the detector 44 corresponding to the camera, the detecting terminal 40 preferably is positioned at upper area in the racks, like the detecting terminal 40a shown in the FIG. 5, to take the picture as being capable of showing a lot of bottles 70.

Further the detector 44 can be an IR (Infrared) light source and an IR (Infrared) censor. The IR light source outputs IR light, then the IR sensor receives a reflect light of the IR light output from the IR light source. The detecting terminal 40 determines an existence of the bottles based on time received the reflect light.

In addition the detector 44 can be a weight scale. The weight scale weights the bottles 70 displayed on the shelf 60a. The detecting terminal 40 transmits weight of the bottles 70 on the rack 61 or 62 as the stock status. Herewith the management device 30a can infer the remaining bottles 70 from the weight of the bottles 70. The management device 30a may send an alert to the deliverer 200 when the weights of the bottles 70, detected by the scale weight, is less than a predetermined value.

The detecting terminal 40a, 40b and 40c are connected to and controlled by the management device 30a. The management device 30a preferably is connected to a plurality of the detecting terminals 40. The detecting terminal 40a, 40b and 40c may be also connected to and controlled by the management device 30b on another shelf 60b.

Moreover the detector 44 can be a wireless reader 10 and a Tag 20. In case of the FIG. 5, a plurality of wireless readers 10 are installed on an upper surface of the first rack 61 and the second rack 62 of the shelf 60b. In contrast, a plurality of tags 20 are installed on a lower surface of the first rack 61 and second rack 62 of the shelf 60b. One of the wireless readers 10 read at least one of ID#s (identification numbers) corresponding to the tag 20 positioned in the same rack. But if the bottle 70 are present between the wireless reader 10 and the tag 20, the bottle 70 interferes with the reading operation of the wireless reader 10. Especially in a case of employing a technology of RFID (Radio-frequency identification), liquid including water tends to block or otherwise interfere with the tag reading operation by RFID technology, due to for example, attenuation, absorption, reflection, refraction, diffraction and/or scattering. Hereby the detecting terminal 40 can determine whether the bottles 70 are present on the tags 20 based on the detection result of the wireless reader.

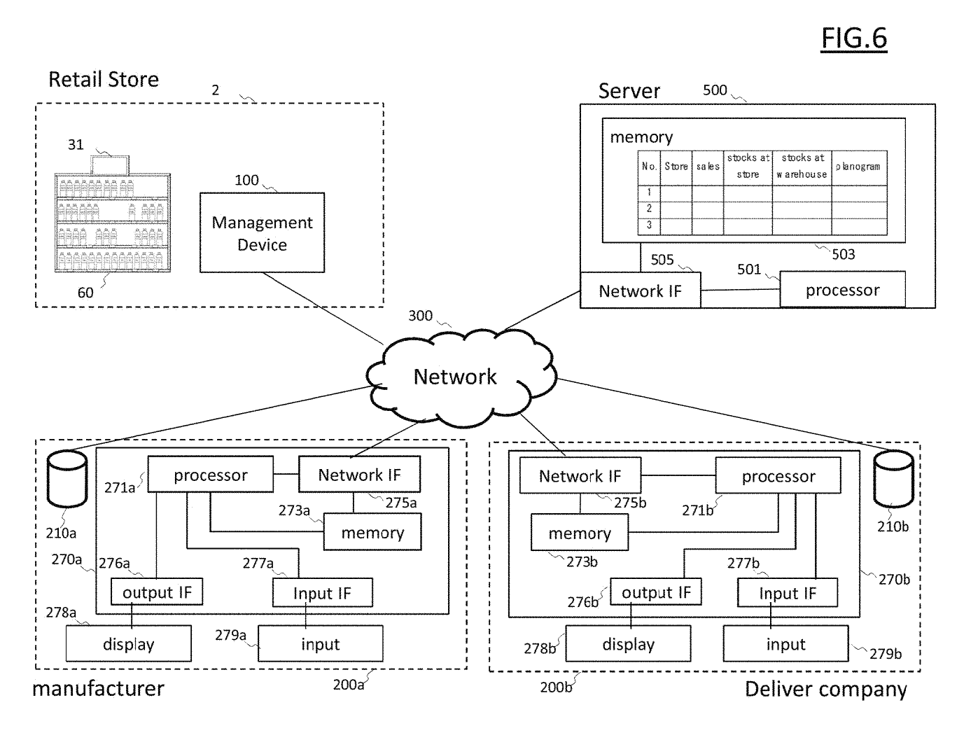

For instance, the wireless reader 10 positioned on the second rack 62 of the shelf 60b can read the tag 22d and 20e. However it cannot read the tag 20f due to the bottle 72f. In other words, the bottle 72f, especially water in the bottle 72f, interferes with the reading operation for the tag 20f. FIG. 6 is another example of the stock management system 1 in accordance with a feature of the disclosure. The stock management system 1 further includes a stock management server 500 connected to the network 300. Although FIG. 6 does not show, actually the stock management system 1 includes a plurality of retail stores 2 which are each located in different places and each retail store install the detecting system 100.

The stock management server 500 has at least a stock management processor 501 configured by one or more processors, a stock management memory 503 configured by one or more memories and a network IF 505. The stock management processor 501 is a main controller of the stock management server 500 and executes a program or instruction stored in the stock management memory 503. The stock management processor 501 may be communicated with the detecting system 100, the manufacturer 200a or the delivery company 200b via the network IF 505. Thus the network IF 505 may be a data transmitter or a data receiver. The stock management processor 501 may transmit any data stored in the stock management memory 503 to the detecting system 100, the manufacturer 200a or the delivery company 200b via the network IF 505. Further the stock management processor 501 stores data transmitted from the detecting system 100, the manufacturer 200a or the delivery company 200b. The stock management memory 503 includes, for example, store information, sales information, stock status information of the retail store 2 and/or the warehouse 230a, and planogram information for each retail store 2. Those information are described in detail below.

A display 31 placed on the shelf 60 in the retail store 2 may display images or videos stored in the memory 34 of the management device 30 (shown in FIG. 3) of the detecting system 100. The display 31 may display any ads, signage or information with respect to products arranged on the shelf 60. The processor 32 of the management device 30 may control what images or videos the display 31 displays. The display 31 may correspond to one or some of alert output 49a, 49b and 49c. If so, the display 31 may output the alert mentioned above as well.

The manufacturer 200a further includes an access computer 270a that may be located in the office 220a, the warehouse 220a, distribution vehicle 250a or any facilities for the manufacturer 200a. Or the access computer 270a may correspond to the mobile terminal 240a. The access computer 270a includes a processor 271a, a memory 273a, a network IF 275a, an output IF 276a and an input IF 277a. The processor 271a displays data stored in the memory 273a. Further the processor 271a displays, on a display 278a, data stored in the server 210a or the stock management memory 503 by accessing them via the network 300. The server 210a or the memory 273a may have the same data stored in the stock management memory 503. A user (e.g. worker of the manufacturer 200a) can check data including store information, sales information, stock status information of the retail store 2 and/or the warehouse 230a, and planogram information or the like by letting those information display on the display 278a. A user also can input something into the access computer 270a or operate the access computer 270a by using an input 279a. The input 279a may be one of a combination of a mouse, a keyboard, a touch panel and any physical/software buttons.

The delivery company 200b further includes an access computer 270b that may be located in the office 220b, the warehouse 230b, distribution vehicle 250b or any facilities for the delivery company 200b. Or the access computer 270b may correspond to the mobile terminal 240b. The access computer 270b includes a processor 271b, a memory 273b, a network IF 275b, an output IF 276b and an input IF 277b. The processor 271b displays data stored in the memory 273b. Further the processor 271b displays, on a display 278b, data stored in the server 210b or the stock management memory 503 by accessing them via the network 300. The server 210b or the memory 273b may have the same data stored in the stock management memory 503. A user (e.g. worker of the delivery company 200b) can check data including store information, sales information, stock status information of the retail store 2 and/or the warehouse 230b, and planogram information or the like by letting those information display on the display 278b. A user also can input something into the access computer 270b or operate the access computer 270b by using an input 279b. The input 279b may be one of a combination of a mouse, a keyboard, a touch panel and any physical buttons.

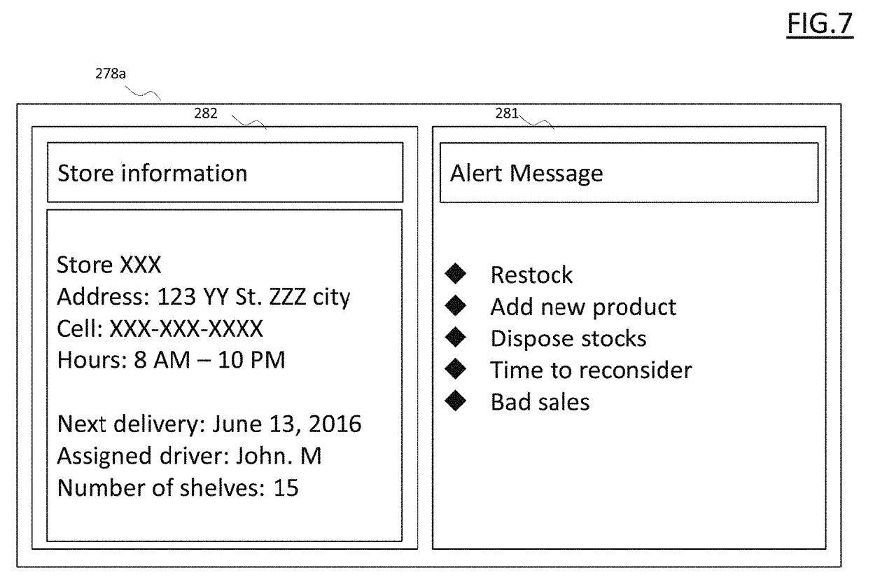

FIG. 7 is an alert message transmitted from the stock management server 500 in accordance with a feature of the disclosure. The stock management processor 501 transmits the alert message 281 like FIG. 7 to the access computer 270a when detecting one or some alerts. As a result, the manufacturer 200a recognizes stock status of the retail store 2 or the warehouse 230a, 230b. Further the stock management processor 501 recommends the manufacturer 200a as an alert that planogram should be changed, based on several information described below. Planogram also means an arrangement of products on the shelf 60 in the retail store 2. It is better for improving sales that each planogram is optimized for each retail store 2. Thus each retail store 2 has an original or unique planogram which is optimized for itself. Each planogram is stored in the stock management memory 503, but it may be stored in other memories (e.g. the server 210a, the memory 273a, the server 273b or the memory 273b) that the manufacturer 200a can access.

As shown in the FIG. 7, the stock management processor 501 may transmit store information 282 together with the alert message 281. Otherwise, the stock management processor 501 itself may read from memories which stores several store information and output on the display 278a upon receiving the alert message 281 including a store# from the stock management server 500. Herewith a user of the access computer 270a can recognize easily which store is alerted when receiving the alert message 281, that is a good timing for reconsidering the planogram in order to re-optimize it. The store information 282 includes at least store#, an address of the store, phone No., business hours, the number of shelves and whole capacity for products. Further the store information 282 may include delivery records. In the FIG. 7, the display 278a shows the last date on which products were restock and a driver who restocked on the last date.

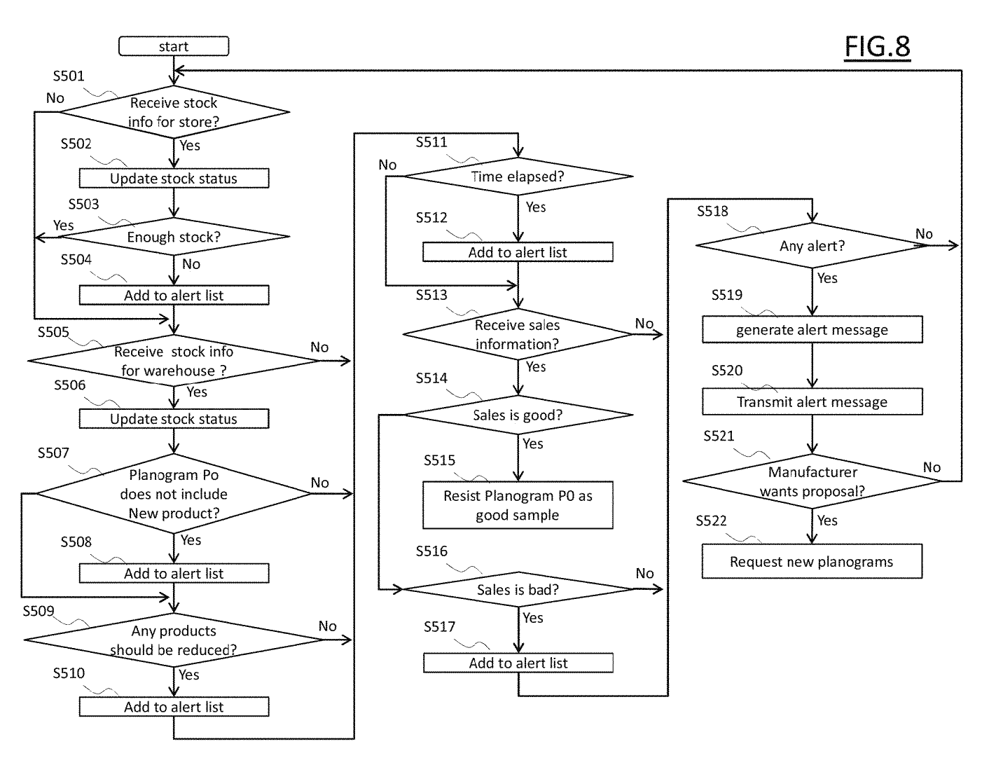

FIG. 8 is a flow chart of the stock management server 500 in accordance with a feature of the disclosure. FIG. 8 shows processes to transmit the alert message 281. When the stock management processor 501 receives stock information for the retail store 2 from the detecting system 100 via the network 300 (Yes of Step S501), the stock management processor 501 updates stock status for the retail store 2 stored in the stock management memory 503 (Step S502). The received stock information includes for instance, the remaining number of each product in the retail store 2. Thereby the latest stock status is stored in the stock management memory 503. Then the stock management processor 501 determines whether the retail store 2 remains enough stocks based on the latest stock status for the retail store 2 (Step S503). When the stock management processor 501 determines that the retail store 2 does not remain enough stocks (No of Step S503), adds this alert to an alert list (Step S504). In this case, “Restock”, one of alert messages shown in FIG. 7 is transmitted as the alert message 281.

When the stock management processor 501 receives stock information for the warehouse 230a from the any computer belongs to the manufacturer 200a via the network 300 (Yes of Step S505), the stock management processor 501 updates stock status for the warehouse 2 stored in the stock management memory 503 (Step S506). Then the stock management processor 501 checks whether stocks in the warehouse 230a includes a new product which has never sold. When the new product is not included in a present planogram P0 (Yes of Step S507), the stock management processor 501 adds this alert to the alert list (Step S508). In this case, “Add new product”, one of alert messages shown in FIG. 7 is transmitted as the alert message 281. Thereby it lets the manufacturer 200a know that the new product which should be promoted would be not arranged at the retail store 2 since the planogram P0 for the retail store 2 does not include the new product and the deliverer restocks products into the shelf 60 according to the planogram. In addition, when a certain product should be reduced, in other words, when the certain product has remained too many stocks in the warehouse 230a (Yes of Step S509), the stock management processor 501 adds this alert to the alert list (Step S510). In this case, “Dispose stocks”, one of alert messages shown in FIG. 7 is transmitted as the alert message 281. The stock management processor 501 may add a name of the certain product into the alert message 281.

When the stock management processor 501 determines that a predetermined time has elapsed from a certain beginning time (Yes of Step S511), the stock management processor 501 adds this alert to the alert list (Step S512). In this case, “Time to reconsider”, one of alert messages shown in FIG. 7 is transmitted as the alert message 281. The certain beginning time mentioned above in the Step 511, for example, may correspond to the last time that products were restocked or the last time that planogram was updated. In addition, the certain beginning time may be reset when the products are restocked to the retail store 2 or when the planogram is updated.

When the stock management processor 501 receives sales information (e.g. sales per month) for the retail store 2 from any computer belongs to the manufacturer 200a or the retail store 2 via the network 300 (Yes of Step S513), the stock management processor 501 determines whether the sales for the retail store 2 is good (Step 514). The sales may be evaluated absolutely or relatively. For example, when the sales exceed a desired value that the manufacturer 200a set, or when the retail store 2 has the top three sales among a plurality of retail stores belonging to the stock management system 1, the retail store 2 is determined as “sales is good”. When the sales for the retail store 2 is good (Yes of Step 514), the present planogram P0 set for the retail store 2 is resisted as a good sample in the stock management memory 503 (Step S515). In contrast, when the sales for the retail store 2 is not good (No of Step 514), the stock management processor 501 determines whether the sales for the retail store 2 is bad (Step 516). Similarly the sales may be evaluated absolutely or relatively. For example, when the sales fall below a predetermined value that the manufacturer 200a set, or when the retail store 2 has the worst three sales among a plurality of retail stores belonging to the stock management system 1, the retail store 2 is determined as “sales is bad”. The stock management processor 501 adds this alert to the alert list (Step S517). In this case, “Bad sales”, one of alert messages shown in FIG. 7 is transmitted as the alert message 281.

After steps S501-S517 being processed, when no alert is detected (No of Step S518), processes return to a start of this flowchart. Or, when no alert is detected (No of Step S518), the stock management processor 501 may stop processes for confirming alerts mentioned above or start processes for confirming alerts mentioned above with respect to another retail store belonging to the stock management system 100. when one or more alerts are detected during the Step S501-S517 (Yes of Step S518), the stock management processor 501 generates the alert message 281 based on the alert list (Step S520) and transmits the generated alert message 281 to the manufacturer (Step S521). In addition, the stock management processor 501 confirms whether the manufacturer 200a wants any proposal with respect to planogram. The manufacturer 200a could resister in advance whether they want the proposal or not. When the manufacturer 200a does not require the proposal (No of Step S521), processes may return to a start of this flowchart, otherwise, the stock management processor 501 may stop processes for confirming alerts mentioned above or start processes for confirming alerts mentioned above with respect to another retail store belonging to the stock management system 1. In contrast, when the manufacturer 200a requires the proposal (Yes of Step S521), the stock management processor 501 recognizes as new planogram is requested (Step S522).

As described above, the stock management processor 501 can give notices regarding to plural kinds of alerts to the manufacturer 200a. In addition the manufacturer 200a may arrange conditions for alerting by itself in advance. For example a worker of the manufacturer 200a may input the conditions for alerting to the access computer 270a via the input 279a. Then the processor 271a transmits the input conditions for alerting to the stock management server 500. Than the stock management processor 501 receives the conditions for alerting and the stores them into the stock management memory 503.

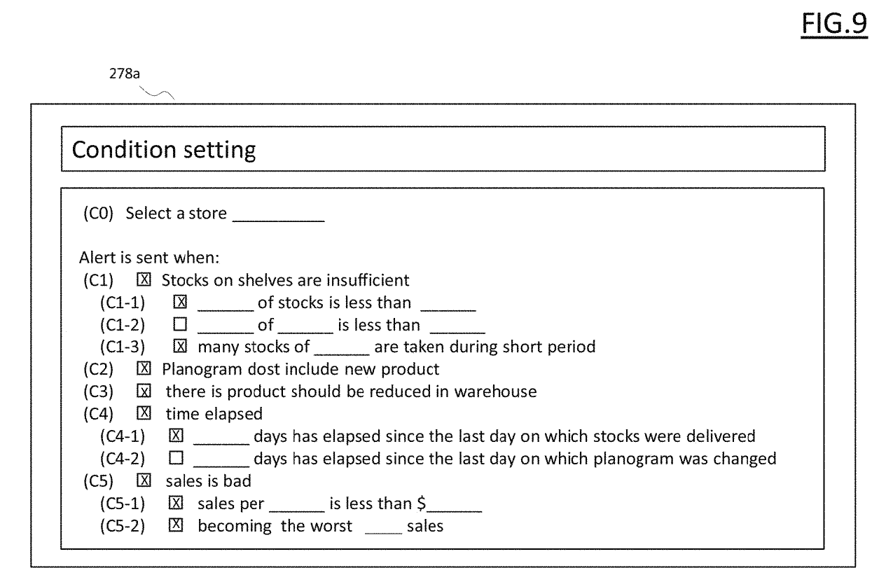

FIG. 9 is an example of setting conditions for alerting in accordance with a feature of the disclosure. These setting conditions are displayed on the display 278a, further a user of the access computer 270a selects one or some of listed conditions. In this case of FIG. 9, conditions (C1)-(C5) are selected. As you can see, each check box for the conditions (C1)-(C5) is checked. The selected conditions (C1)-(C5) are stored in the stock management memory 503 and used when the stock management processor 501 tries to detect any alert such as FIG. 7.

In a condition (C0), one retail store is selected among from a plurality of retail stores belonging to the stock management system 1 in response to user input via the input 279a. The user fills out one of the retail stores into an input box of the condition (C0). Then the user would pick up any conditions (C1)-(C5) for setting alert conditions for the selected store in the condition (C0). After picked up, the stock management processor 501 outputs an alert when any conditions (C1)-(C5) are satisfied, but alert messages subject to be sent to the manufacture 200a depending on what conditions are satisfied. As used herein, the term “fill out” means any inputting actions (such as typing words or selecting from options).

The condition (C1) substantially corresponds to the Step S503 shown in FIG. 8 and mentioned above. So if the condition (C1) is not selected by the user, the stock management processor 501 may skip the Step S503 and other steps related thereto (e.g. Steps S501, 502, and S504). On the other hands, if the condition (C1) is selected as an alert condition, the stock management processor 501 determines whether stocks on shelves, that is, remained stocks in the selected store is sufficient. For example, the number of the remained stocks in the selected store is compared with a threshold value, then the stock management processor 501 determines that stocks on the shelves are enough and does not output an alert with respect to the condition (C0) (e.g. “Restock” shown in the FIG. 7). The user further can set more specifically as to the meaning of “insufficient” in the condition (C1) by using sub-conditions (C1-1)-(C1-3). In the sub-condition (C1-1), the user can set like “number of stocks is less than 100” or “rate of stocks is less than 0.3 (30%)”. Therefore, the user can fill out a subject (like number of rate) for detecting “insufficient” into a left input box of the sub-condition (C1-1), further fill out a threshold value, with respect to the subject in the left input box, into a right input box. In the sub-condition (C1-2), the user can further designate a subject product in addition to the subject for detecting and threshold value. That is, the user can set like “number of water is less than 100” or “rate of water is less than 0.3 (30%)”. Thus the subject for detecting is filled out into a left input box, a name of the designated product is filled out into a middle input box, and the threshold value is filled out into a right input box in the sub-condition (C1-2). In the sub-condition (C1-3), the user also designate a product in an input box. As setting the sub-condition (C1-3), the stock management processor 501 can detect a sharp drop of the designated product. For example, the stock management processor 501 outputs an alert when detecting that stocks more than predetermined/user-designated number or rate is taken by the customer during a predetermined/user-designated period (e.g. 3 hours) by receiving a plurality of the stock information transmitted in different times from the selected retail store.

The condition (C2) substantially corresponds to the Step S507 shown in FIG. 8 and mentioned above. So if the condition (C2) is not selected by the user, the stock management processor 501 may skip the Step S507 and other steps related thereto (e.g. Step S508). On the other hands, if the condition (C2) is selected as an alert condition, the stock management processor 501 determines whether a new product is included in a present planogram set for the selected retail store in the condition (C0). Then if the new product is not included in the planogram, the stock management processor 501 outputs an alert in order to remind the manufacturer 200a of a change of the present planogram since the delivery personnel restocks products to stores in accordance with the planogram set in the stock management memory 503, that is, the delivery personnel would not restock the new product as long as the present planogram is maintained.

The condition (C3) substantially corresponds to the Step S509 shown in FIG. 8 and mentioned above. So if the condition (C3) is not selected by the user, the stock management processor 501 may skip the Step S509 and other steps related thereto (e.g. Step S510). On the other hands, if the condition (C3) is selected as an alert condition, the stock management processor 501 determines whether there is a product stored in the warehouse 230a that should be reduced due to any reason. For example the stock management processor 501 outputs an alert when the number of stocks of a specific product stored in the warehouse 230a exceeds a predetermined/user-designated threshold value. Thereby the stock management processor 503 reminds the manufacturer 200a of a situation where too many stocks of the specific product are remained in the warehouse 230a.

The condition (C4) substantially corresponds to the Step S511 shown in FIG. 8 and mentioned above. So if the condition (C4) is not selected by the user, the stock management processor 501 may skip the Step S511 and other steps related thereto (e.g. Step S512). On the other hands, if the condition (C4) is selected as an alert condition, the stock management processor 501 determines whether a predetermined/user-designated period is elapsed. Thus the stock management processor may conduct periodically alert check processes such as the flowchart explained with FIG. 8. Or, the user further can set more specifically as to the meaning of “time elapsed” in the condition (C4) by using sub-conditions (C4-1) and/or (C4-2). In the sub-condition (C4-1), the user can set like “3 days has elapsed since the last day on which stocks were delivered”. In a similar manner, in the sub-condition (C4-1), the user can set like “3 days has elapsed since the last day on which planogram was changed”. By inputting a number into each input box in the condition (C4-1) and (C4-2), the user can specify a timing for alerting in detail. In the condition (C4-1), criteria for judging “time elapsed” is based on the last time that stocks were delivered to the selected store by the delivery personnel. In the condition (C4-2), criteria for judging “time elapsed” is based on the last time that a planogram set for the selected store was changed.

The condition (C5) substantially corresponds to the Step S516 shown in FIG. 8 and mentioned above. So if the condition (C5) is not selected by the user, the stock management processor 501 may skip the Step S516 and other steps related thereto (e.g. Step S517). On the other hands, if the condition (C5) is selected as an alert condition, the stock management processor 501 determines whether sales of the selected store are bad. That may be determined absolutely or relatively. For example, the user can set like “sales per month is less than $10,000” in the sub-condition (C5-1) to be determined absolutely. In this case, the user can fill out a period (e.g. day, mouth or year) for calculating sales into a left input box of the sub-condition (C5-1), further fill out a threshold value (money) into a right input box of the sub-condition (C5-1). Thereby the stock management processor 501 outputs alert when sales (per month) of the selected store do not reach the predetermined value filled out into the right input box of the sub-condition (C5-1). In addition, the user can set like “becoming the worst 3 sales” in the sub-condition (C5-2) to be determined relatively. In this case, the user can fill out a ranking number (e.g. 3) into an input box of the sub-condition (C5-2). Thereby the stock management processor 501 outputs alert when sales (per month or like this) of the selected store reach, for instance, the worst 3 among a plurality of retail stores belonging to the stock management system 1.

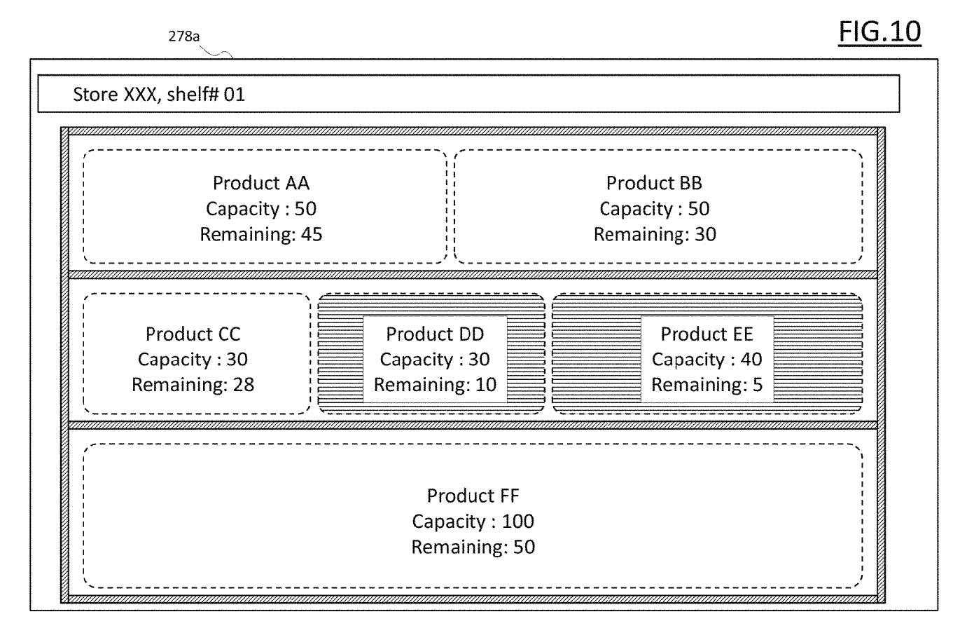

FIG. 10 is an example of the planogram displayed on the display 278a and stored in the stock management memory 503 in accordance with a feature of the disclosure. The planogram shown in FIG. 10 defines each position of products AA-FF placed on one of shelves (#01) disposed in the store XXX. Further the planogram defines capacities for each product. In case of the product AA, there is a space where 50 of the products AA can be placed on an upper rack of the shelf #01. In addition the processor 271a of the access computer 270a may display actual remaining numbers for each product by using the stock information stored in the stock management memory 503 together with the planogram such as FIG. 10. Herein, products, like as products DD or EE, whose actual remaining numbers less than predetermined/user-designated value or rate may be highlighted (e.g. flashing, changing colors, or the like) compared other products.

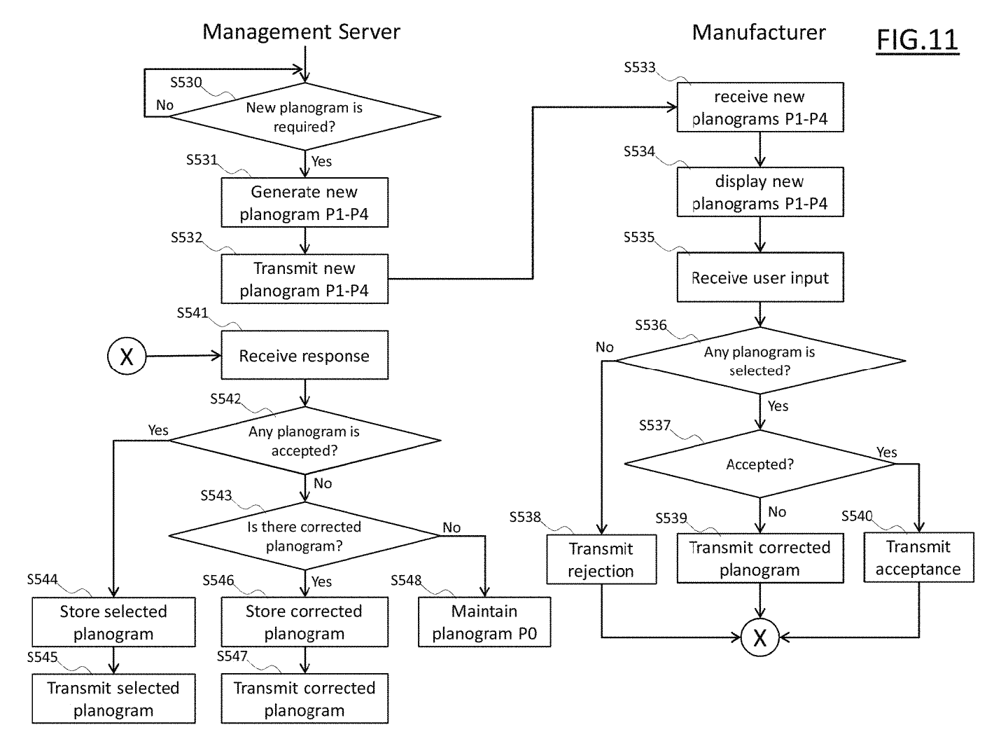

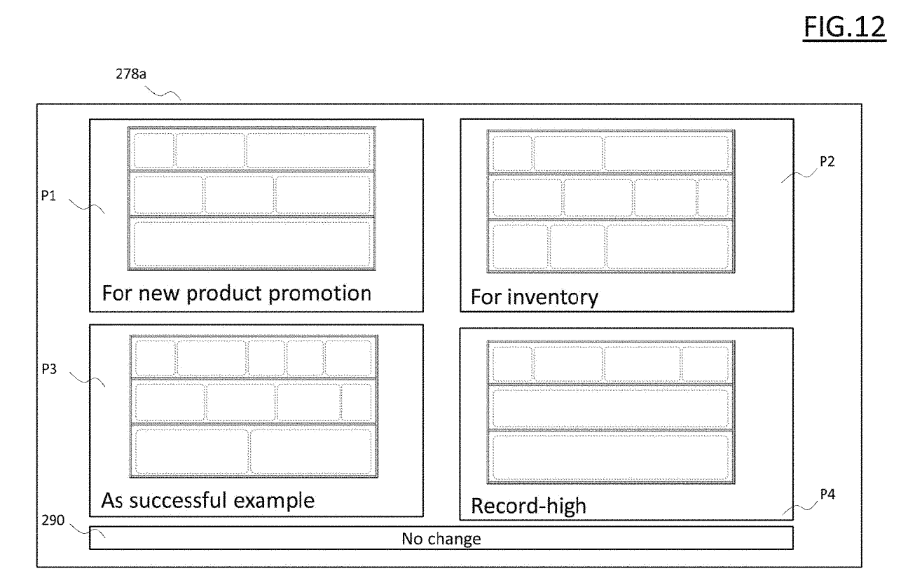

FIG. 11 is a flowchart for changing a planogram in accordance with a feature of the disclosure. When a new planogram is required (Yes of Step S530) such as Step S522 of FIG. 8, the stock management processor 501 generates a plurality of new planograms P1-P4, each of which has a different arrangement of products (Step S532). The stock management processor 501 may generate new planograms P1-P4 when receiving a request from the manufacturer 200a even if alerts are not detected. The stock management processor 501 transmits the new planograms P1-P4 to the Manufacturers 200a (Step S532) in order to propose them. Then the access computer 270a receives the new planograms P1-P4 (Step S533). The processor 271a of the access computer 270a displays the new planograms P1-P4 such as FIG. 12.

FIG. 12 is an example of images displaying the new planograms P1-P4 in accordance with a feature of the disclosure. Each feature for new planograms is shown in the display 278a as well. The new planogram P1 is recommended for a new product promotion. For instance, when the manufacturer 200a starts to sell the new product, the new planogram P1 is generated so that the new product is arranged at well-sold position, like next to a popular product. The new planogram P2 is recommended for inventory. The new planogram P3 is generated based on any succeeded planogram of another retail store. As showing the new planogram P3, the manufacture 200a can consult a planogram of another store, which is stored in the stock management memory 503 as a good sample such as resisted in the Step S515. The new planogram P4 is generated based on or corresponds to a planogram recorded high-record sales of the selected retail store in the past.

The access computer 270a receives user input to select a planogram (Step S535). If the user of the access computer 270a does not select any new planograms P1-P4 (No of Step S536), that is, the user selects an option 290, “no change”, the processor 271a transmits a rejection signal to the stock management server 500 (Step S538). But if the user selects and accepts one of the new planograms P1-P4 (Yes of Step S537), the processor 271a transmits an acceptance signal with information about the selected new planogram to the stock management server 500 (Step S540). Also the user may correct the selected new planogram by themselves with the input 279a after selecting one of the new planograms P1-P4. In this case (No of Step S537), the processor 271a transmits the corrected planogram to the stock management server 500 (Step S539).

The stock management processor 501 receives one of responses transmitted from the manufacturer 200a (Step S542). When the received response includes the acceptance signal and information with respect to the selected planogram (Yes of Step S542), the stock management processor 501 stores the selected planogram into the stock management memory 503 (S544), that is, the present planogram P0 is updated. Then the stock management processor 501 transmits the stored planogram to especially the detecting system 100, mobile terminal 240 as a new resisted planogram (Step S545). In another situation, when the received response includes the corrected planogram by the manufacture 200a, the stock management processor 501 stores the corrected planogram into the stock management memory 503 (Step S546), that is, the present planogram P0 is updated. Then the stock management processor 501 transmits the stored planogram to especially the detecting system 100, mobile terminal 240 as a new resisted planogram (Step S547). In further another situation, when the received response includes the rejection signal, the stock management processor 501 maintains the present planogram P0 (Step S548).

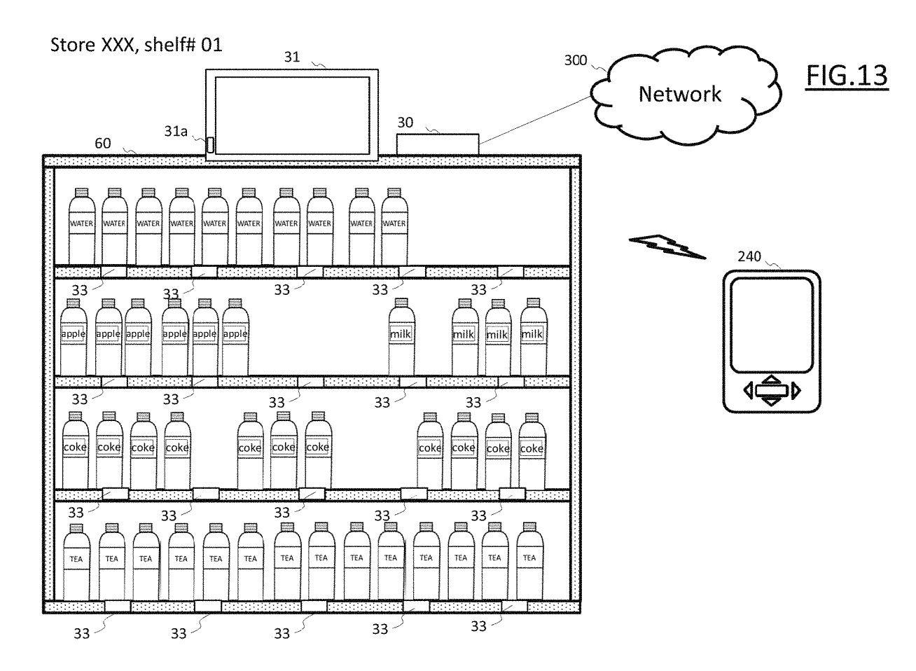

FIG. 13 is a shelf with displays in a retail store in accordance with a feature of the disclosure. As shown in FIG. 13, the display 31 is attached to the shelf 60 located in a retail store 2. In addition, a plurality of small displays 33 are attached to each racks of the shelf 60. Each small display 33 outputs a price corresponding to a product (tea, water, coke, apple or milk). These small displays 33 has a wired connection or a wireless connection to the management device 30, and is controlled by the management device 30. Thus displayed prices by the small displays 33 are changed in response to instructions from the management device 30.

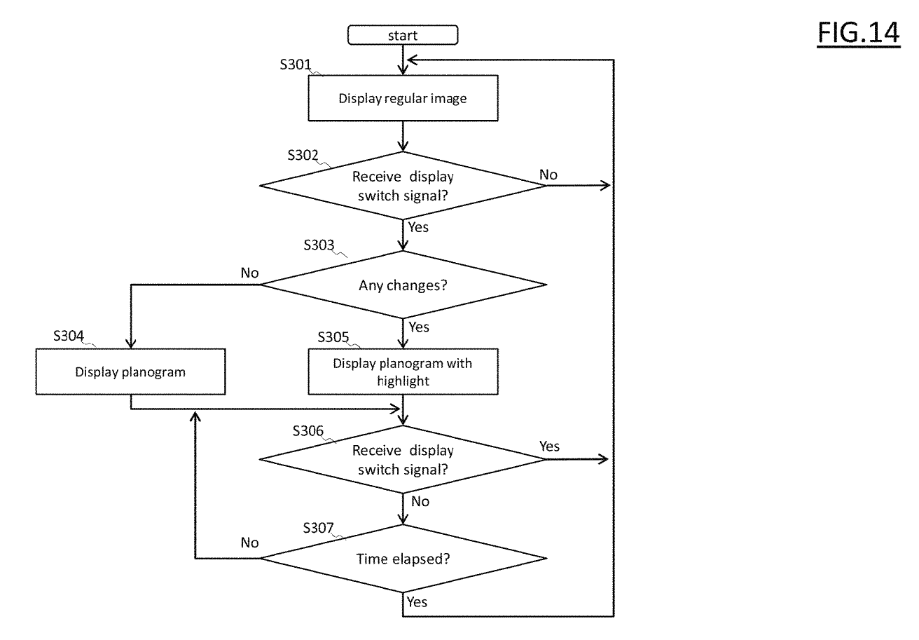

FIG. 14 is a flowchart for changing the display 31 or small displays 33 attached to the shelf 60 in accordance with a feature of the disclosure. The display 31 displays any ads, signage or information with respect to products arranged on the shelf 60 as a regular image. In a similar fashion, the small displays 33 display a price corresponding to each product as a regular image. But if the management device 30 receives a display switch signal, management device 30 displays the resisted planogram on the display 31 or small displays 33. The display switch signal may be transmitted from the mobile terminal 240 in response to a user input or may be transmitted by pushing a button 31a. When the resisted planogram is new (Yes of Step S303), the management device 30 displays the resisted planogram on the display 31 and further displays a name corresponding to one of products according to the resisted planogram on each small display 33 (Step S305). In addition, in each display 31 and small display 33, a changed portion of the resisted planogram compared to the last planogram is highlighted (Step S305). But if the resisted planogram has not changed, the management device 30 displays the resisted planogram on the display 31 and the small displays as well (Step S304) without highlighted. Then if the management device 30 receives the display switch signal again or if the predetermined time has elapsed, the management device 30 displays the regular image on the display 31 and the small displays 33.

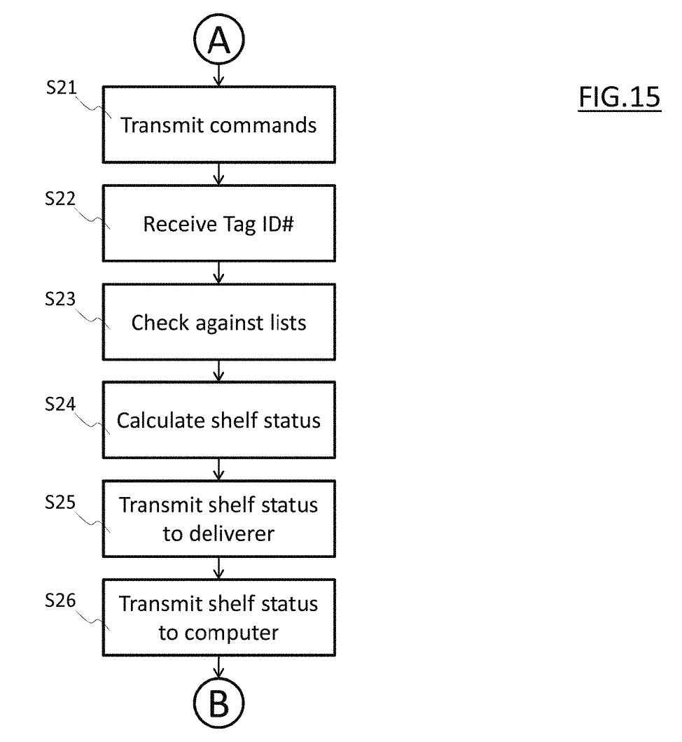

FIG. 15 is a flow chart of the management device 30 in accordance with a feature of the disclosure. FIG. 15 is explained with configuration disclosed in FIG. 5, as one of examples, as described in detail below. The management device 30 (30b) transmits a command to the detecting terminal 40 being provided with the wireless reader 10 as the detector 44 (Step S21).

Upon receiving the command, the microcomputer 42 (including microcomputer 42a, 42b or 42c) controls the wireless reader 10 to read tag ID#s corresponding to each tag 20. Then the microcomputer 42 transmits tag IDs being read by the wireless reader 10. The management device 30 receives the tag IDs from the detecting terminal 40 (Step S22).

Tag ID#s are stored in the memory 34 in advance. Thus the processor 32 of the management device 30 checks the tag IDs, received from the detecting terminal 40, against tag ID#s listed in the memory 34 (Step 23). In other words, the processor 32 compares received tag ID#s with preliminarily stored tag ID#s.

The processor 32 calculates the stock status on the shelf 60 based on the comparison result (Step S24). For instance, if the processor matches five tag ID#s, the processor 32 counts five bottles 70 as stock-out. The memory 34 may store the maximum or original number of the bottles 70 being capable of putting on the shelf 60 or the rack. Thereby the processor can calculate the number of remaining bottles 70 by calculating a margin of between the maximum number and the counted number as stock-out.

The processor 32 transmits the stock status generated in Step S24 to the deliverer 200 (Step S25) via the communication device 36a or 36b. Alternatively the processor 32 may further arrange or edit the stock status before transmitting it.

The processor 23 also transmits the stock status, generated in Step S24, to the computer 50 via the communication device 36a. The computer 50 may display the stock status automatically on the display 52. Thereby the employees or the representative of the retail store 2 can recognize the stock status of each product or shelf easily.

The computer 50 and/or microcomputer 42a-c can include a set of instructions that can be executed to cause the computer 50 and/or microcomputer 42a-c to perform any one or more of the methods or computer based functions disclosed herein. The computer 50 and/or microcomputer 42a-c may operate as a standalone device or may be connected, for example, using a network 300, 400.

In a networked deployment, the computer 50 and/or microcomputer 42a-c may operate in the capacity of a server or as a client user computer in a server-client user network environment, or as a peer computer system in a peer-to-peer (or distributed) network environment, including but not limited to femtocells or microcells. The computer 50 can also be implemented as or incorporated into various devices, such as a personal computer (PC), a tablet device, a set-top box (STB), a personal digital assistant (PDA), a smartphone, a mobile device, a global positioning satellite (GPS) device, in-vehicle system, a palmtop computer, a laptop computer, a desktop computer, a communications device, a wireless telephone, smartphone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single computer 50 is illustrated, the term “computer” shall also be taken to include any collection of systems or sub-systems that individually or jointly execute a set, or multiple sets, of instructions to perform one or more computer functions.

The network 300, 400, management device 30, tags, detecting terminal and/or other features of the disclosure may be of any suitable type, including but not limited to wired, RF, RFID, WiFi, Bluetooth, Bluetooth Low Energy (BLE), Active Bat, near field communication, Zigbee, ANT, and Foundation Fieldbus H1.

It is noted that the computer 50, microcomputer 42a-c, detector 44a-c, power controller 46c and/or other elements of the disclosure may also be autonomous in terms of a power supply such that they may receive power via electromagnetic induction, RF transmission, a rechargeable battery, micro energy capture, solar power, heat transfer, geothermal, energy harvesting and the like.

As used herein, the term “manufacturer” means any supplier (such as warehouse, retailer, vendor, manufacturer, wholesaler, producer, grower and the like) of stockable items, including but not limited to clothing, food, beverages, liquids.

As used herein, the term “delivery personnel” means any human or nonhuman entity capable of delivering stockable items.

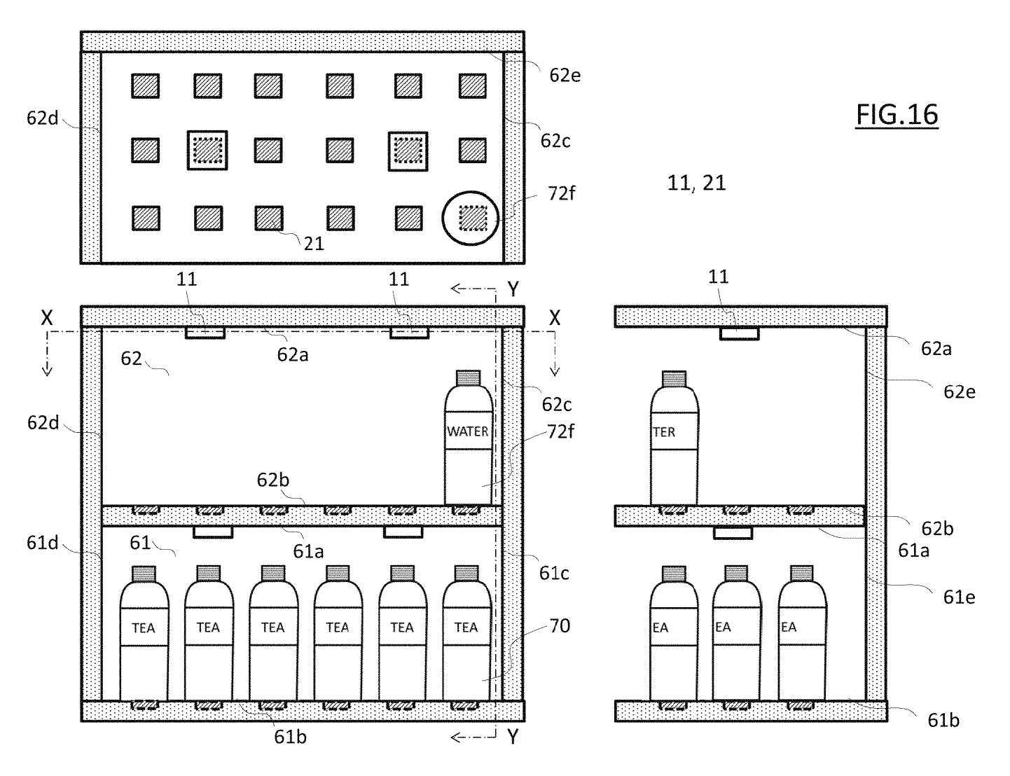

Other layout examples of the wireless reader 10 and the tag 20 described below with FIG. 16-25.

FIG. 16 is each view of the shelf 60 with readers and tags in accordance with a feature of the disclosure. The FIG. 16 (a) is a front view of the shelf 60 as viewed from customers. The FIG. 16 (b) is an upper view of the shelf 60 corresponding to a cross-section view from line X-X. The FIG. 16 (c) is a side view of the shelf 60 corresponding to a cross-section view from line Y-Y.

The shelf 60 has the first rack 61 including an upper surface 61a, a lower surface 61b facing the upper surface 61a, right side surface 61c and left side surface 61d facing the right side surface 61d. The first rack 61 further includes a back surface 61e substantially perpendicular to the upper surface 61a, the lower surface 61b, the right side surface 61c or the left side surface 61d. The shelf also has the second rack 62 including an upper surface 62a, a lower surface 62b facing the upper surface 62a, right side surface 62c and left side surface 62d facing the right side surface 62d. The second rack 62 further includes a back surface 62e substantially perpendicular to the upper surface 62a, the lower surface 62b, the right side surface 62c or the left side surface 62d.

The detecting terminal 40 (not shown in FIG. 16) has wireless readers 11 and tags 21 as the detector 44. Each of the wireless reader 11 is arranged on an upper surface 61a or 62a. Also tags 21 are arranged on a lower surface 61b or 62b. The arrayed tags 21 have on the first rack 61 or second rack 62 have three lines (rows), each of which having six tags 21 in a traverse direction and six lines (columns), each of which having three tags 21, in longitudinal direction. The wireless readers 11 are positioned above one of the tags 21 on a center line (row) of the three lines.

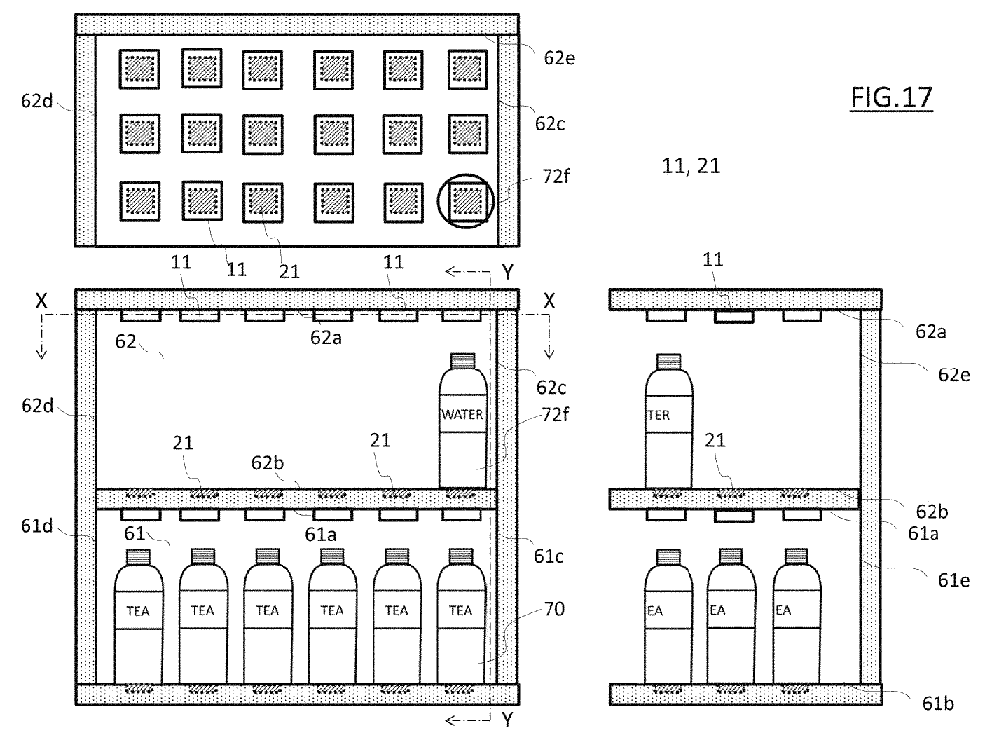

FIG. 17 is each view of a shelf with readers and tags in accordance with a feature of the disclosure. The FIG. 17 (a) is a front view of the shelf 60 as viewed from customers. The FIG. 17 (b) is an upper view of the shelf 60 corresponding to a cross-section view from line X-X. The FIG. 17 (c) is a side view of the shelf 60 corresponding to a cross-section view from line Y-Y.

The detecting terminal 40 (not shown in FIG. 17) has wireless readers 12 and tags 22 as the detector 44. Each of the wireless reader 12 is arranged on an upper surface 61a or 62a. Also tags 22 are arranged on a lower surface 61b or 62b. The arrayed tags 22 on the first rack 61 or second rack 62 have three lines (rows), each of which having six tags 22, in a traverse direction and six lines (columns), each of which having three tags 22, in longitudinal direction. Similarly the arrayed wireless readers 12 on the first rack 61 or the second rack 62 have three lines (rows), each of which having six wireless readers 12, in a traverse direction and six lines (columns), each of which having three wireless readers 12, in longitudinal direction. The wireless reader 12 may read only one tag 22 under itself. Alternatively the wireless reader 12 may read a plurality of tags 22.

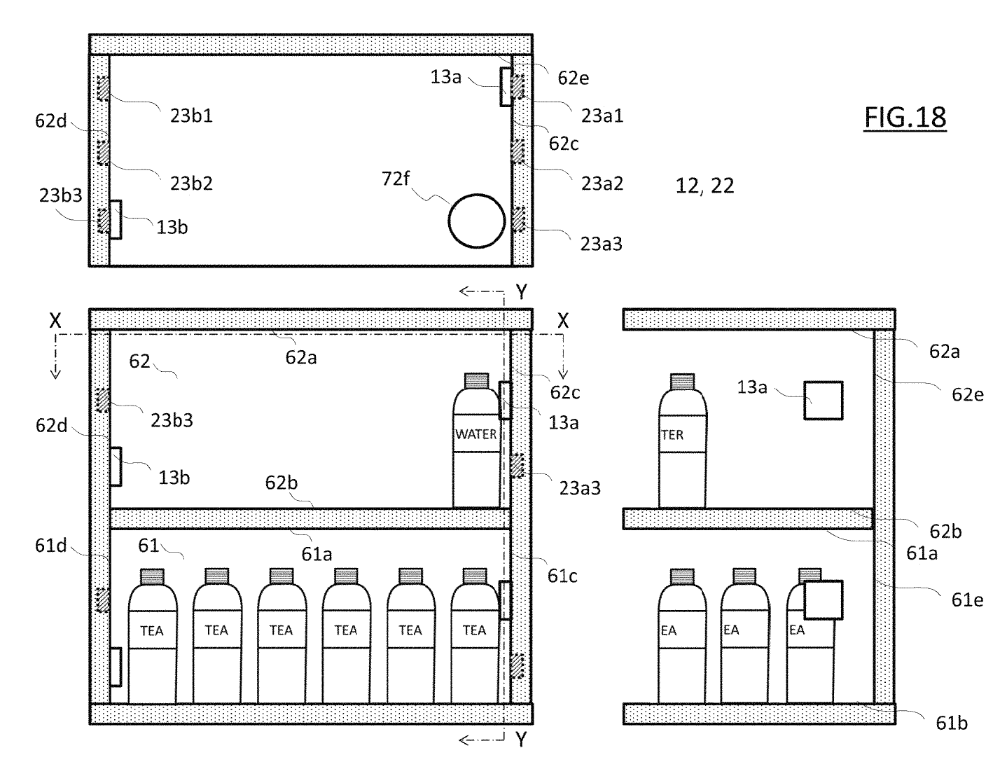

FIG. 18 is each view of a shelf with readers and tags in accordance with a feature of the disclosure. The FIG. 18 (a) is a front view of the shelf 60 as viewed from customers. The FIG. 18 (b) is an upper view of the shelf 60 corresponding to a cross-section view from line X-X. The FIG. 18 (c) is a side view of the shelf 60 corresponding to a cross-section view from line Y-Y.

The detecting terminal 40 (not shown in FIG. 18) has wireless readers 13a, 13b and tags 23a1-23a3, 23b1-23b3 as the detector 44. The wireless reader 13a is arranged on a right side surface 61c or 62c. The wireless reader 13b is arranged on a left side surface 61d or 62d. The tags 23a1, 23a2, and 23a3 are arranged on the right side surface 61c or 62c. The tags 23b1, 23b2 and 23b3 are arranged on the left side surface 61d or 62d. The wireless reader 13a and tags 23b1-23b3 are substantially positioned on the same level. The wireless reader 13b and tags 23a1-23a3 are substantially positioned on the same level. The level defined by the wireless reader 13a and tags 23b1-23b3 is higher than the lever defined by the wireless reader 13b and tags 23a1-23a3.

The wireless reader 23a can read ID#s corresponding to the tags 23b1-23b3. The wireless reader 23b can read ID#s corresponding to the tags 23a1-23a2. In case of FIG. 18, the wireless reader 23b arranged on left side surface 62d cannot read the ID# corresponding to the tag 23a3 due to the bottle 72f.

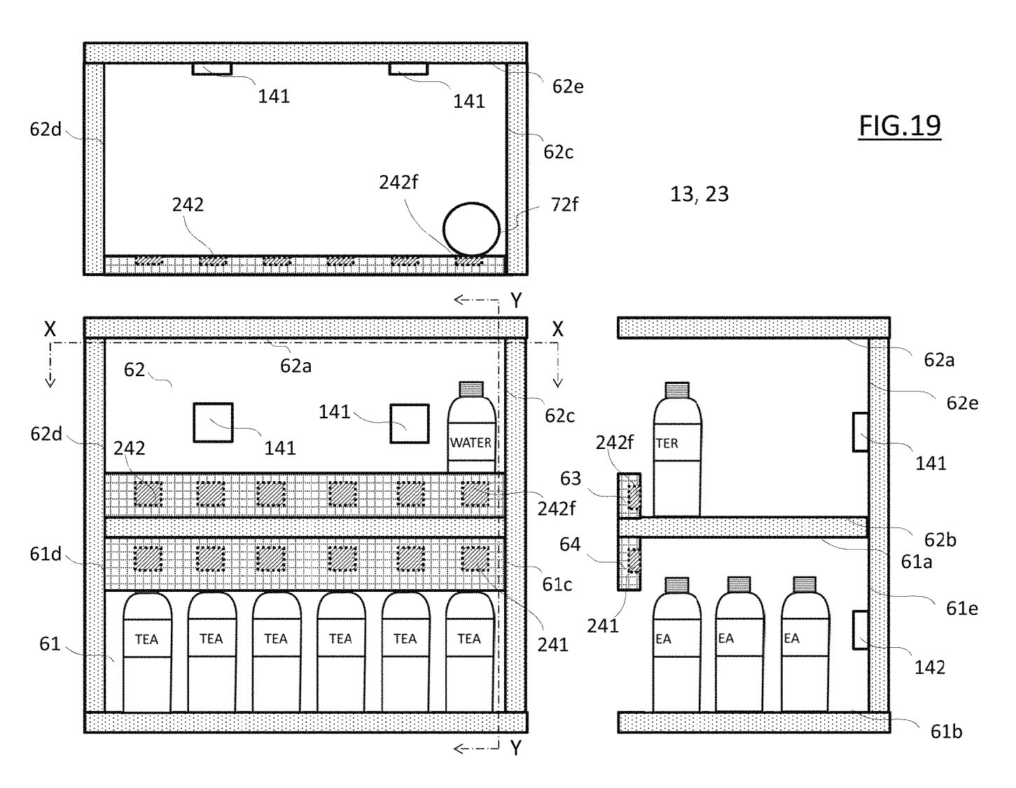

FIG. 19 is each view of a shelf with readers and tags in accordance with a feature of the disclosure. The FIG. 19 (a) is a front view of the shelf 60 as viewed from customers. The FIG. 19 (b) is an upper view of the shelf 60 corresponding to a cross-section view from line X-X. The FIG. 19 (c) is a side view of the shelf 60 corresponding to a cross-section view from line Y-Y.

The shelf 60 further include stopper 63 and 64 which prevent the bottles 70 from being dropped from the shelf 60. The stopper 63 is connected to the upper surface 61a or projected downward from the upper surface 61a. The stopper 64 is connected to the lower surface 62b or projected upward from the lower surface 62b.

The detecting terminal 40 (not shown in FIG. 19) has wireless readers 141, 142, tags 241 and 242. The wireless readers 141 are arranged on a back surface 61e. The wireless readers 142 are arranged on a back surface 62e. Six tags 241 are arranged on inner surface of the stopper 63. Six tags 242 (including tag 242f) are arranged on inner surface of the stopper 64. The wireless readers 141 on the back surface 61e are positioned lower than the height of the bottles 70. Thereby the reading operation of the wireless readers 141 on the back surface 61e are interrupted by the bottles 70 because the (tea) bottles 70 exists between the wireless readers 14 and the tags 63 if the bottles 70 is put on the lower surface 61b.

The wireless readers 141 on the back surface 61e can read ID#s corresponding to the tags 241. The wireless readers 142 on the back surface 62e can read ID#s corresponding to the tags 242. The wireless readers 14 on the back surface 62e cannot read ID# of the tag 242f due to the bottle 72f existing in front of the tag 242f.

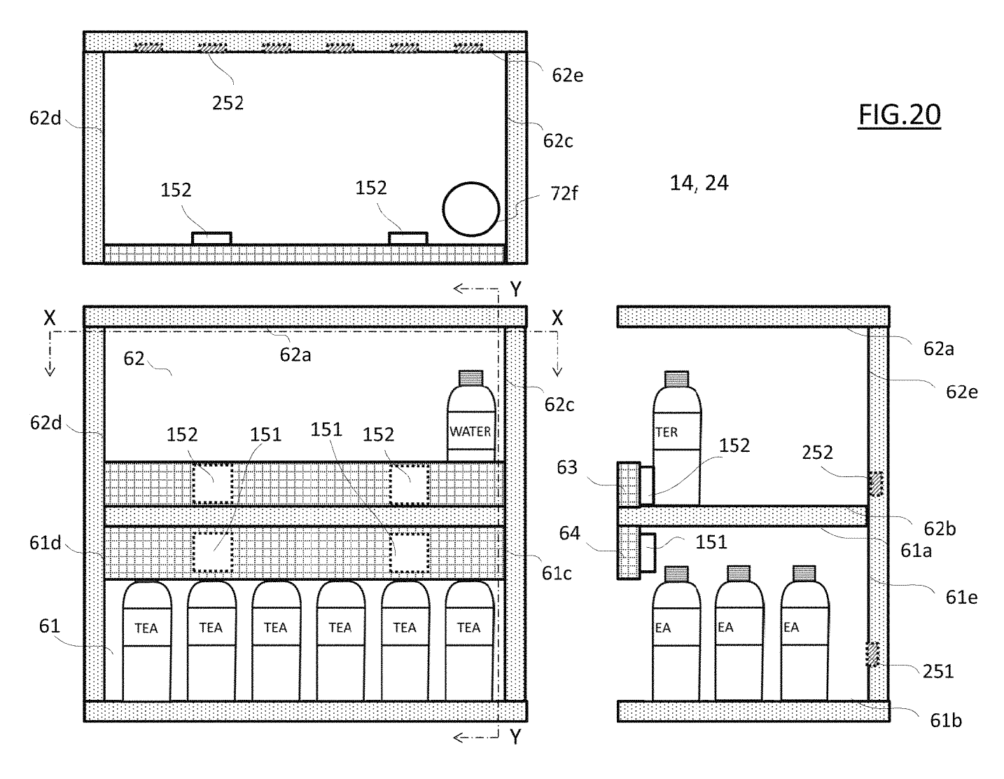

FIG. 20 is each view of a shelf with readers and tags in accordance with a feature of the disclosure. The FIG. 20 (a) is a front view of the shelf 60 as viewed from customers. The FIG. 20 (b) is an upper view of the shelf 60 corresponding to a cross-section view from line X-X. The FIG. 20 (c) is a side view of the shelf 60 corresponding to a cross-section view from line Y-Y.

The detecting terminal 40 (not shown in FIG. 20) has wireless readers 151, 152, tags 251 and 252. The wireless readers 151 are an inner surface of the stopper 64. The wireless readers 152 are arranged on an inner surface of the stopper 63. Six tags 251 are arranged on the back surface 61e. Six tags 252 are arranged on the back surface 62e. The wireless reader 151 and 152 is positioned lower than the height of the bottles 70. The wireless reader 152 and the tags 252 are substantially on the same level.

The wireless readers 151 can read ID#s corresponding to the tags 251. The wireless readers 152 can read ID#s corresponding to the tags 252.

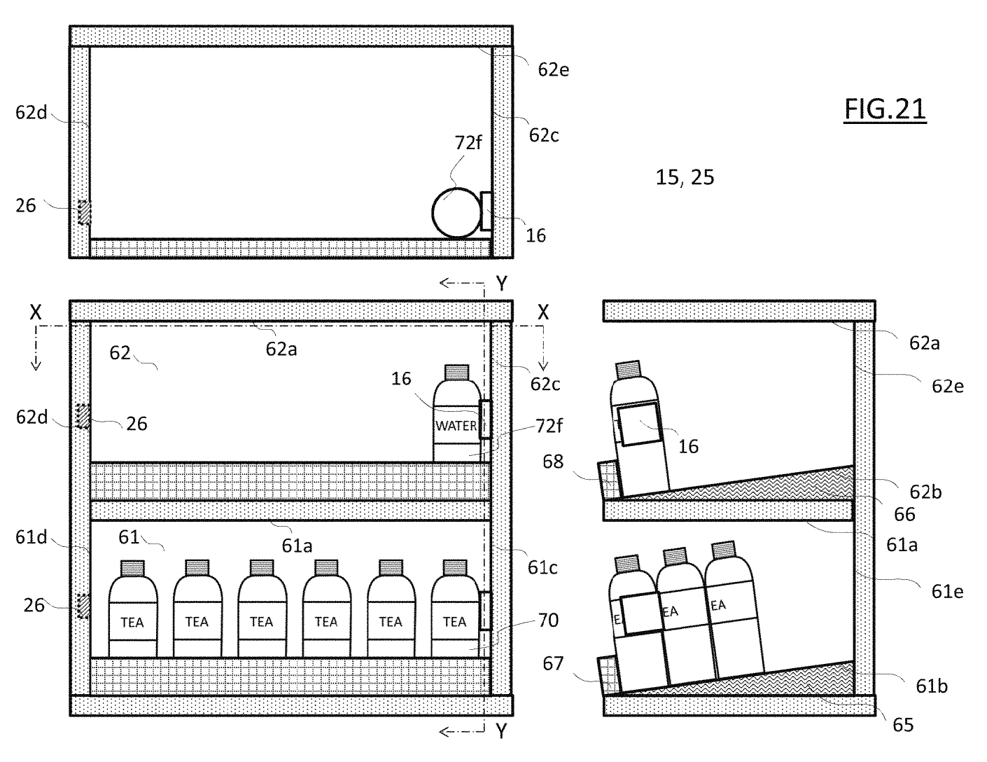

FIG. 21 is each view of a shelf with readers and tags in accordance with a feature of the disclosure. The FIG. 21 (a) is a front view of the shelf 60 as viewed from customers. The FIG. 21 (b) is an upper view of the shelf 60 corresponding to a cross-section view from line X-X. The FIG. 21 (c) is a side view of the shelf 60 corresponding to a cross-section view from line Y-Y.

The shelf 60 further includes a slope 65, 66, stopper 67 and 68. The slope 65 slopes front from the back surface 61e. The slope 66 slopes front from the back surface 62e. Thus bottles 70 slides to front automatically. The stopper 67 is positioned on a front end of the slope 65. The stopper 68 is positioned on a front end of the slope 66.

The detecting terminal 40 (not shown in FIG. 21) has wireless readers 16 and tags 26. The wireless readers 16 are arranged on right side surface 61c or 62c. The tags 26 are arranged on left side surface 61d or 62d. The wireless readers 16 and the tags 26 are positioned lower than bottles 70. The reader 16 and the tag 26 on the first rack 61 are closer to the stopper 67 than the back surface 61e. The reader 16 and the tag 26 on the second rack 62 are closer to the stopper 68 than the back surface 62e. The wireless reader 16 on the right side surface 61c can read ID# corresponding to the tag 26 on the left side surface 61d. The wireless reader 16 on the right side surface 62c can read ID# corresponding to tag 26 on the left side surface 62d.

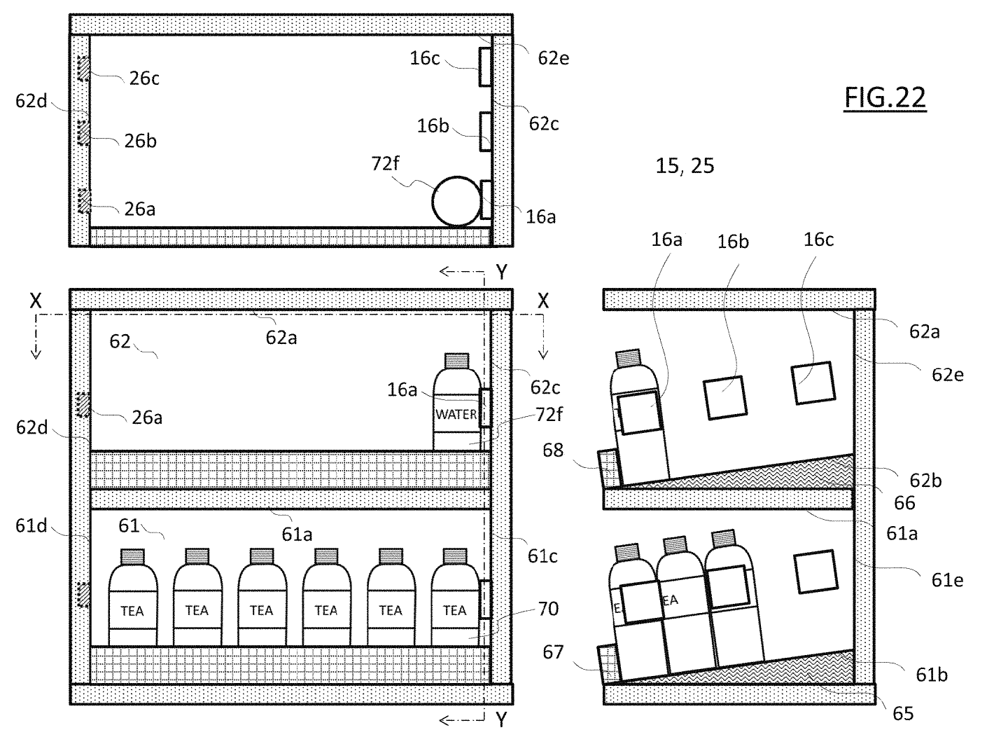

FIG. 22 is each view of a shelf with readers and tags in accordance with a feature of the disclosure. The FIG. 22 (a) is a front view of the shelf 60 as viewed from customers. The FIG. 22 (b) is an upper view of the shelf 60 corresponding to a cross-section view from line X-X. The FIG. 22 (c) is a side view of the shelf 60 corresponding to a cross-section view from line Y-Y.

The detecting terminal 40 (not shown in FIG. 22) has wireless readers 16a-16c and tags 26a-26c. The wireless readers 16a-16c are arranged on the right side surface 61c or 62c. The tags 26a-26c are arranged on the left side surface 61d or 62d. The wireless readers 16a-16c and the tags 26a-26c are positioned lower than bottles 70. The wireless reader 16a-16c on the right side surface 61c can read ID# corresponding to the tag 26 on the left side surface 61d. The wireless reader 16a-16c on the right side surface 62c read ID# corresponding to the tags 26a-26c on the left side surface 62d.

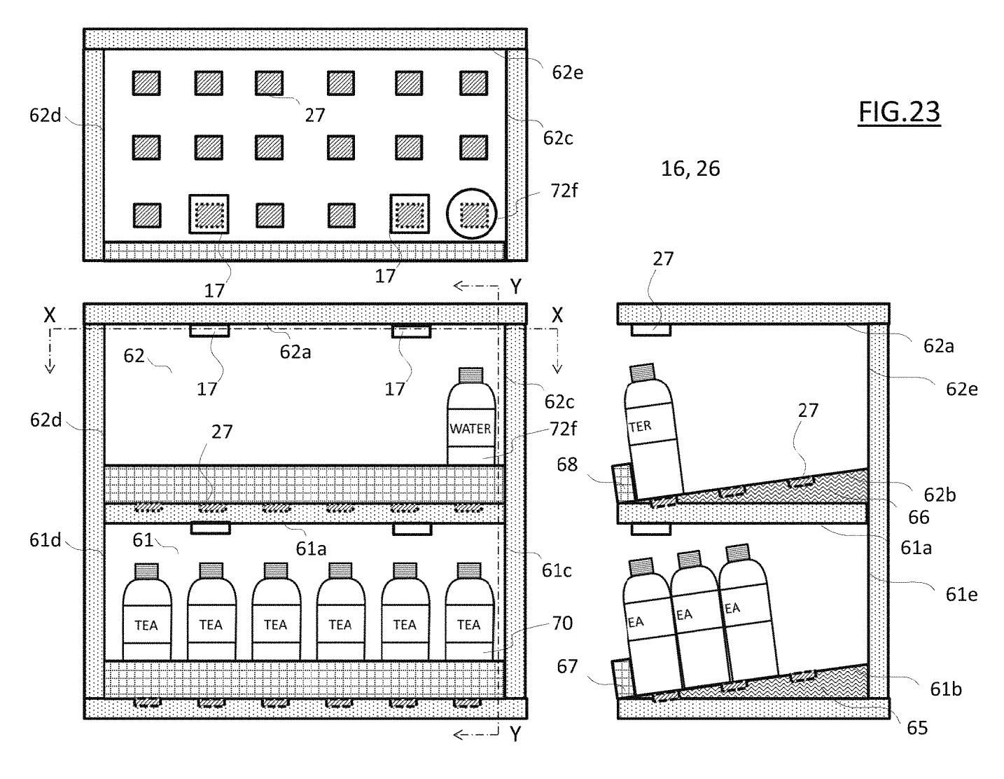

FIG. 23 is each view of a shelf with readers and tags in accordance with a feature of the disclosure. The FIG. 23 (a) is a front view of the shelf 60 as viewed from customers. The FIG. 23 (b) is an upper view of the shelf 60 corresponding to a cross-section view from line X-X. The FIG. 23 (c) is a side view of the shelf 60 corresponding to a cross-section view from line Y-Y.

The detecting terminal 40 (not shown in FIG. 23) has wireless readers 17 and tags 27. The wireless readers 17 are arranged on the upper surface 61a or 62a. The tags 27 are arranged on the lower surface 61b corresponding to a top surface of the slope 65 or on the lower surface 62b corresponding to a top surface of the slope 66. The arrayed tags 27 have on the lower surface 61b or 61b have three lines (rows), each of which having six tags 27 in a traverse direction and six lines (columns), each of which having three tags 27, in longitudinal direction. The wireless readers 17 are positioned above one of the three lines being closest to the front end of the slope 65 or 66. The wireless reader 17 on the upper surface 61a can read ID#s corresponding to the tags 27 on the lower surface 61b. The wireless reader 17 on the upper surface 62a can read ID#s corresponding to the tags 27 on the lower surface 62b.

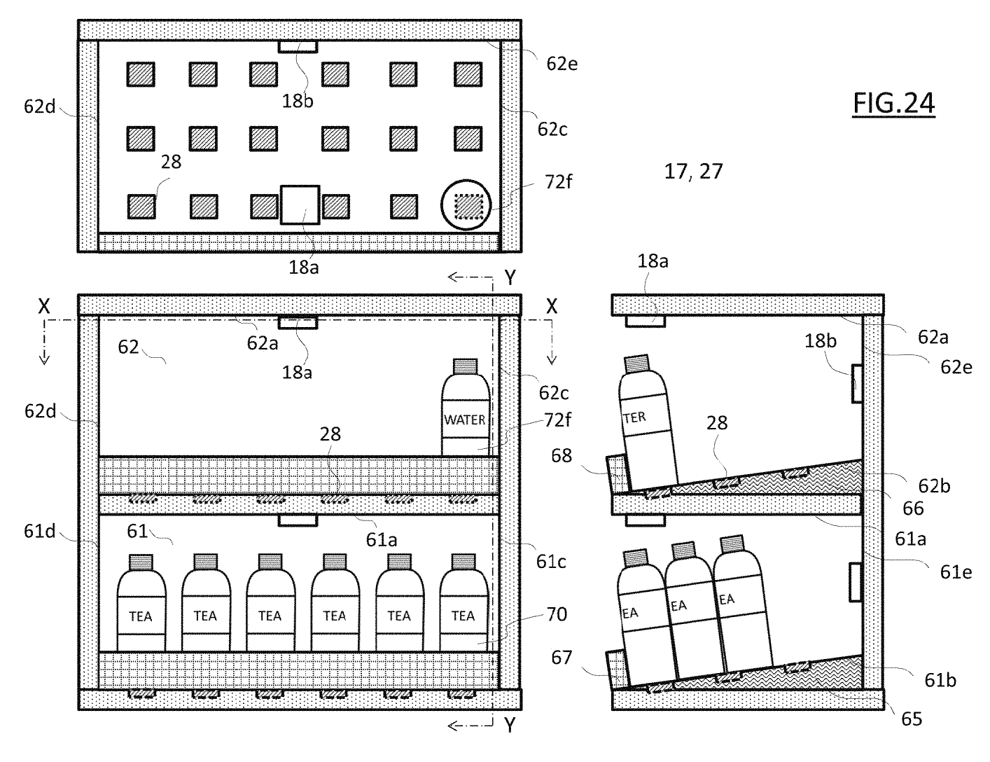

FIG. 24 is each view of a shelf with readers and tags in accordance with a feature of the disclosure. The FIG. 24 (a) is a front view of the shelf 60 as viewed from customers. The FIG. 24 (b) is an upper view of the shelf 60 corresponding to a cross-section view from line X-X. The FIG. 24 (c) is a side view of the shelf 60 corresponding to a cross-section view from line Y-Y.

The detecting terminal 40 (not shown in FIG. 24) has wireless readers 18a, 18b and tags 28. The wireless readers 18a are arranged on the upper surface 61a or 62a. The wireless readers 18b are arranged on the back surface 61e or 62e. The tags 28 are arranged on the lower surface 61b corresponding to a top surface of the slope 65 or on the lower surface 62b corresponding to a top surface of the slope 66. The arrayed tags 28 have on the lower surface 61b or 62b have three lines (rows), each of which having six tags 28 in a traverse direction and six lines (columns), each of which having three tags 28, in longitudinal direction. The wireless readers 18a are positioned above one of the three lines being closest to the front end of the slope 65 or 66.

The wireless reader 18a on the upper surface 61a and the wireless reader 18b on the back surface 61e can read ID#s corresponding to the tags 28 on the lower surface 61b. The wireless reader 18a on the upper surface 62a and the wireless reader 18b on the back surface 62e can read ID#s corresponding to the tags 28 on the lower surface 62b.

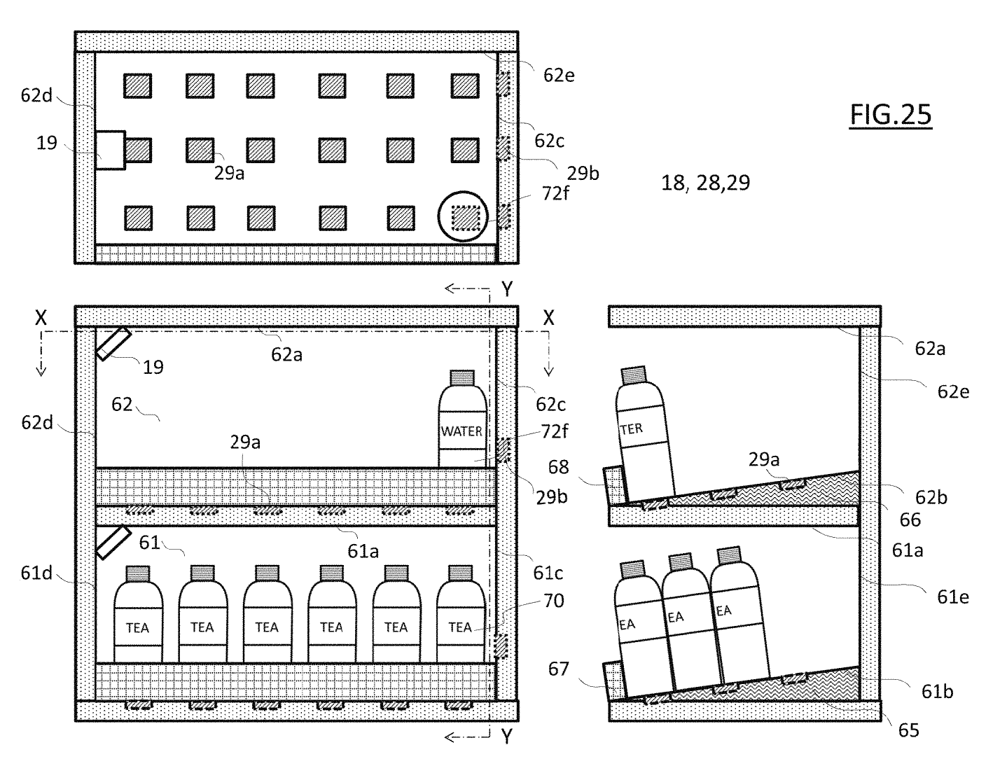

FIG. 25 is each view of a shelf with readers and tags in accordance with a feature of the disclosure. The FIG. 25 (a) is a front view of the shelf 60 as viewed from customers. The FIG. 25 (b) is an upper view of the shelf 60 corresponding to a cross-section view from line X-X. The FIG. 25 (c) is a side view of the shelf 60 corresponding to a cross-section view from line Y-Y.

The detecting terminal 40 (not shown in FIG. 25) has wireless readers 19, tags 29a and 29b. The wireless readers 19 are arranged at a corner made by the upper surface 61a and the left side surface 61d or made by the upper surface 62a and the left side surface 62d. The tags 29a are arranged on the lower surface 61b or 62b. The arrayed tags 29a have on the lower surface 61b or 62b have three lines (rows), each of which having six tags 29a in a traverse direction, and six lines (columns), each of which having three tags 29a, in longitudinal direction. The wireless readers 19a are positioned above a center line of the three lines. The tags 29b arranged on the right surface 61c or the 62c. The tags 29b are positioned lower than the bottles 70.

The wireless reader 19 at the corner made by the upper surface 61a and the left side surface 61d reads ID#s of the tags 29a on the lower surface 61b or tags 29b on the right side surface 61c. The wireless reader 19 at the corner made by the upper surface 62a and the left side surface 62d reads ID#s of the tags 29a on the lower surface 62b or tags 29b on the right side surface 62c.

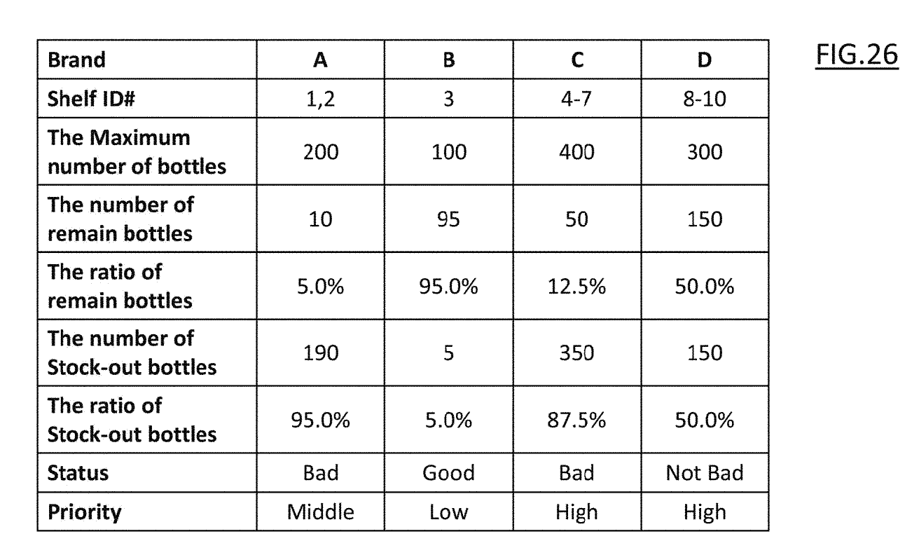

FIG. 26 is a table showing stock status in accordance with a feature of the disclosure. The management device 30, the detecting terminal 40 or the computer 50 may transmit the stock status as shown FIG. 26. According to FIG. 26, it is indicated the stock status regarding to the products of brands (A)-(E). For instance the products of the brands (A) are usually displayed on the two shelves 60 (#1 and 2). Each of the shelves 60 (#1-10) has a space being possible to put one hundred bottles 70.

The ratio of remain bottles is calculated from the maximum number of the bottles and the number of remain bottles (the ratio of remain bottles=the number of remain bottles/the maximum number of the bottles). Also, the ratio of stock-out bottles is calculated from the maximum number of the bottles and the number of stock-out bottles (the ratio of stock-out bottles=the number of stock-out bottles/the maximum number of the bottles). The maximum number of bottles may be stored in the memory 34.

The status may be determined based on bottle number information corresponding to at least one of the ratio of remain bottles, the number of remain bottles, the ratio of stock-out bottles or the number of stock-out bottles. The priority may be designated arbitrarily in accordance with a user input. In general the high priority means hot-selling products. In other words, the deliverer 200 does not want status so that there are no or a few of the products of the high priority (e.g. brand (C) or (D)).

Therefore the detecting system 100 may send an alert indicating low number of the products to the deliverer 200 with different criteria. For instance, when the bottle number information regarding the low priority products (e.g. brand (B)) is less than a first threshold, the detecting system 100 sends alert to the deliverer 200. In contrast, when the bottle number information regarding the high priority products (e.g. brand (C) or (D) is less than a second threshold, the detecting system 100 sends alert to the deliverer 200. Further the second threshold is less than the first threshold.

For instance, if the detector 44 corresponds to wireless readers and tags disclosed in FIG. 16, 17, 23, 24 or 25, the detecting terminal 40 or management device 30 can calculate the bottle number information mentioned above.

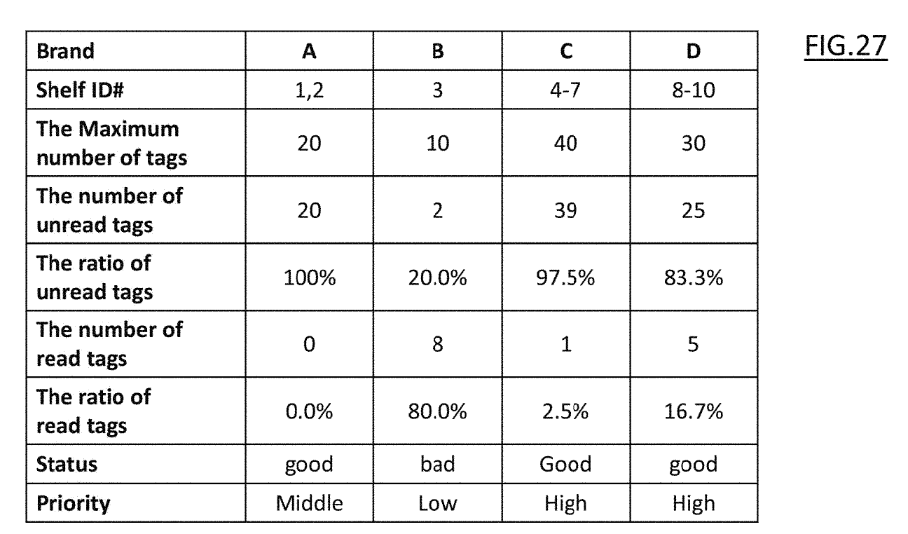

FIG. 27 is a table showing stock status in accordance with a feature of the disclosure. The management device 30, the detecting terminal 40 or the computer 50 may transmit the stock status as shown FIG. 27. Each of the shelves 60 (ID#1-10) is attached ten tags.

The ratio of unread tags is calculated from the maximum number of tags and the number of unread tags (the ratio of unread tags=the number of unread tags/the maximum number of the tags). Also, the ratio of read tags is calculated from the maximum number of the tags and the number of read tags (the ratio of read tags=the number of read tags/the maximum number of tags). The maximum number of tags may be stored in the memory 34.

The status may be determined based on bottle number information corresponding to at least one of the ratio of unread tags, the number of unread tags, the ratio of read tags or the number of read tags. The priority may be designated arbitrarily in accordance with a user input. Also the detecting system 100 may send an alert indicating low number of the products to the deliverer 200 with different criteria similar to the above descriptions.

For instance, if the detector 44 corresponds to wireless readers and tags disclosed in at least one of FIG. 16-25, the detecting terminal 40 or management device 30 can calculate the number information mentioned above.

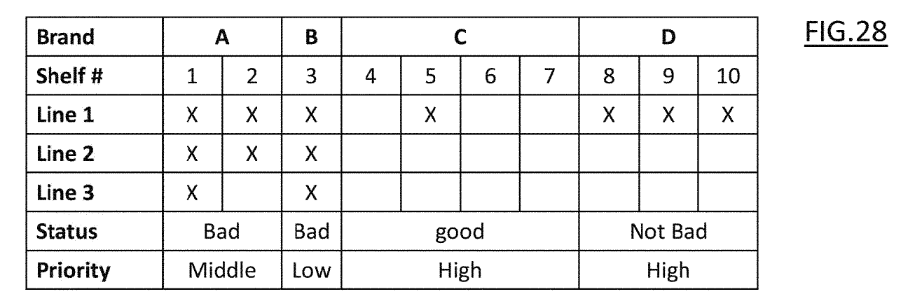

FIG. 28 is a table showing stock status in accordance with a feature of the disclosure. The management device 30, the detecting terminal 40 or the computer 50 may transmit the stock status as shown FIG. 27.

“X”, in FIG. 28, means that bottles are not detected in each line 1-3 or tag on each line 1, 2, or 3 is read by the wireless reader. In case of brand (A), there are no bottles in line 1-3 in the Shelf 60 (#1) and line 1 and 2 in the shelf (#2).

Line 1-3 may correspond to any one of lines defined between one of wireless readers and one of tags disclosed above. But the lines are limited to be formed by the wireless reader and the tag disposed on the same rack.

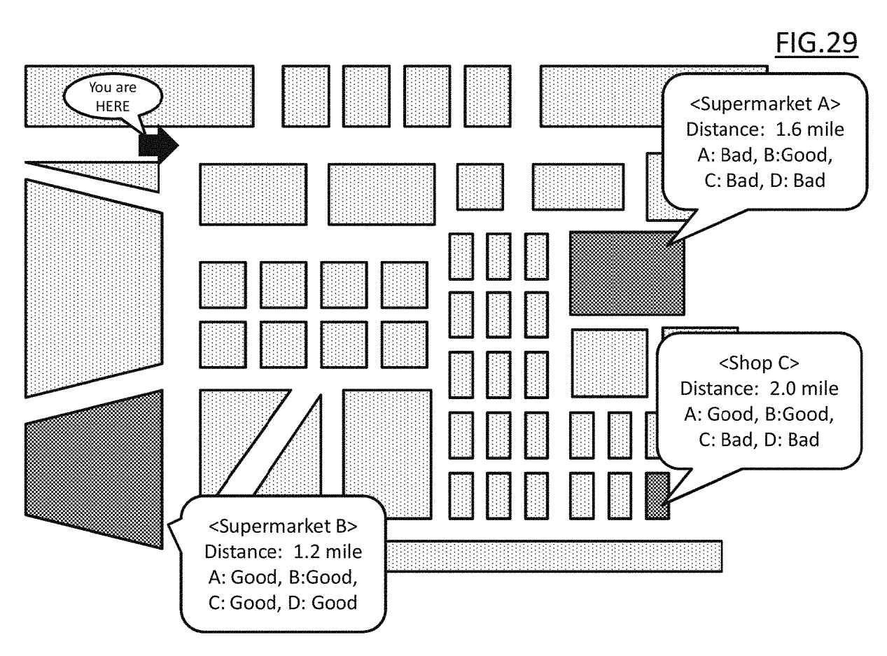

FIG. 29 is a displayed image on the mobile terminal 204 (including mobile terminal 240a or 240b) in accordance with a feature of the disclosure. The mobile terminal 240 may show a current location of itself, for example, based on GPS (Global Positioning System) technology. In addition the mobile terminal 240 may show the stock status for each brand (A)-(D) on the display in each supermarket (A)-(C) located around the current location.

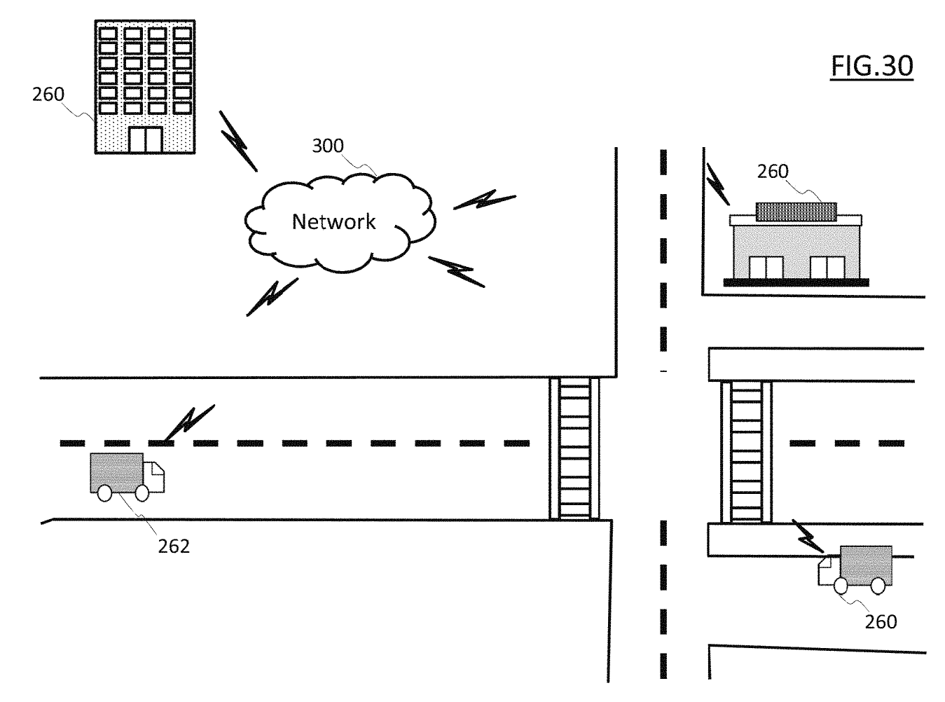

FIG. 30 is an explanatory diagram showing notifications to drivers in accordance with a feature of the disclosure. FIG. 30 shows an office 260, distribution vehicle 261 and 262, each of them corresponding to one of examples of the deliverer 200.

When a device in the office 260 receives the stock status or the alert from the retail store 2, it searches a vehicle having the product necessary for the retail store 2. Then if the device finds the distribution vehicle 261 nearest to the retail store 2, it transmits a request to the distribution vehicle 261, the request commanding a driver of the distribution vehicle 261. However, in case that the driver of the distribution vehicle rejects or ignores the request, the device in the office 260 resend the request to the distribution vehicle 262 being second nearest to the retail store 2.

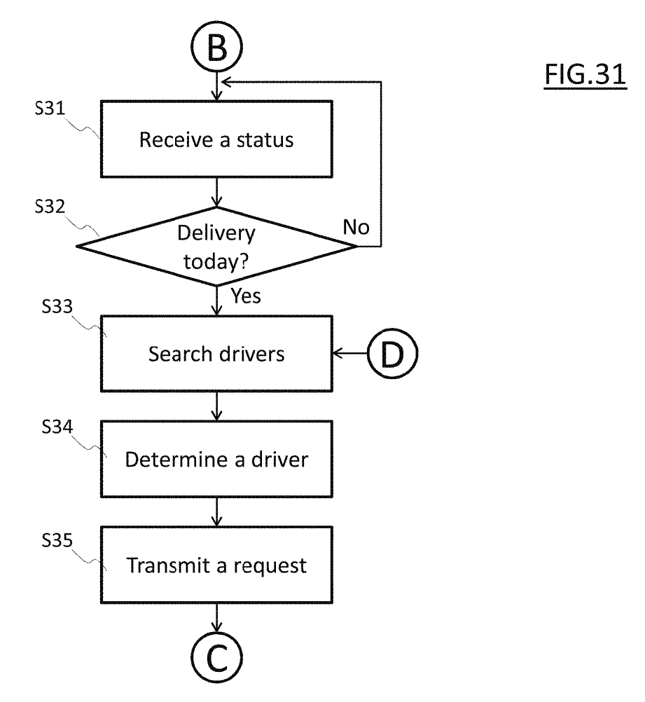

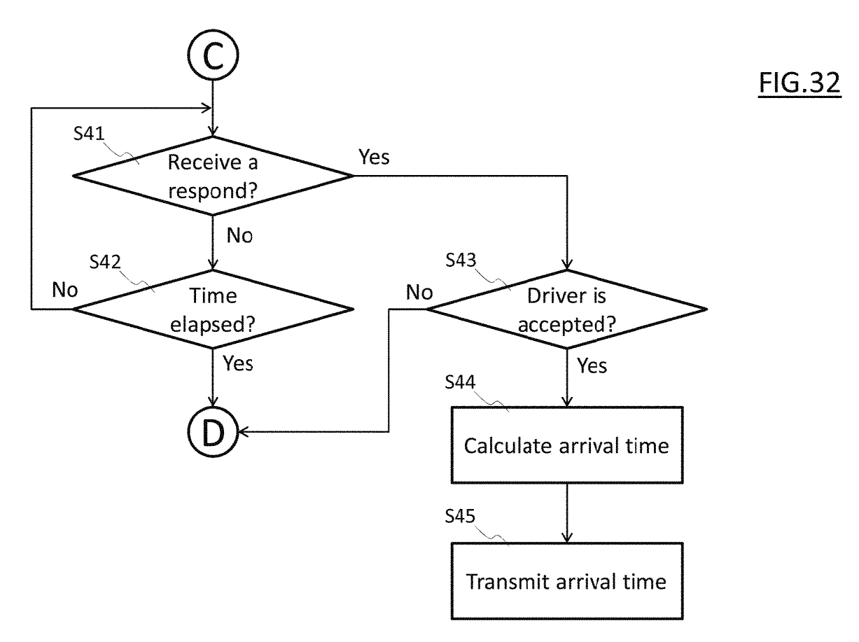

FIG. 31 is a flow chart of the deliverer 200 in accordance with a feature of the disclosure. FIG. 32 is a flow chart of the deliverer 200 in accordance with a feature of the disclosure.

When the deliverer 200 receives the stock status from the detecting system 100 or the retail store 2 (Step S31), the deliverer 200 determines whether they should delivery their products to the retail store 2 based on the received the stock status.

If the deliverer determines not to delivery it today (Step S32), the deliverer 200 returns to waiting state. In contrast, when the deliverer determines to delivery it today (Step S32), the deliverer 200 searches a proper driver around the retail store 2 (Step S33). The deliverer 200 determined a driver based on the searching result in Step S33. (Step S34). Then the deliverer 200 transmits the request to the driver determined in Step S34.

When the driver receives the request from the deliverer 200, the driver is asked to accept the request or not. If the deliverer 200 does not receives a response indicating acceptableness or rejection from the driver (Step S41), the deliverer wait for a predetermined time (Step S42). If the predetermined time is elapsed without receiving the respond (Step S42) or the driver transmits the respond but rejecting the request (Step S43), the deliverer 200 searches another vehicles again (Step S33).

On the other hand, if the deliverer 200 receives the respond from the driver indicating the acceptableness (Step S43), the deliverer 200 calculate an arrival time indicating when the driver arrives the retail store 2 in view of the current location of the driver and road condition around the current location (Step S44). Finally the deliverer 200 transmits the calculated arrival time to the driver or the retail store 2.

The “term computer program” is defined as a sequence of instructions designed for execution by a one or more processors on one or more computer systems. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

A computer program may be stored and/or distributed on a suitable medium, such as a non-transitory optical storage medium or a solid-state medium supplied together with or as part of other hardware, but also be distributed and/or run in other forms, such as via the Internet or other wired or wireless telecommunication systems.

A store stock detection sensor that is a sheet-shaped sensor that is placed on a store shelf and detects the amount of store stock by detecting the number or amount of products placed thereon, wherein a plurality of electric contact points are disposed in the sheet, the electric contact points are brought into contact by the products placed on the sheet, and the contact is detected by a detection circuit disposed outside the sheet.

In the sheet-shaped sensor that is placed on the store shelf and detects the amount of store stock by detecting the number or amount of products placed thereon, at least one side of the sheet can be cut in accordance with the size of the store shelf used. There seems to be no store stock detection sensor may include such a configuration. A configuration of the sheet that can be cut, a wiring pattern has been contrived, etc.

The store stock detecting sensor characterized by detecting the shape of a bottom portion of a product by using a switch group with sufficiently high contact density with respect to the complexity of the shape of the bottom portion of the product and specifying the type of the product based on the shape of the bottom portion. Further advanced stock amount detection can occur while connecting the shape of a bottom surface with a type of a product. For example, a PET bottle of 500 ml and a PET bottle of 2 l obviously have different bottom surface sizes. Therefore, detecting them makes it possible to discriminate both the PET bottoms without measuring the weights by using a complicated sensor.

The sheet-shaped sensor that is placed on the store shelf and detects the amount of store stock by detecting the number or amount of the products placed thereon is characterized by that the detection points on the sheet are non-uniformly distributed. When products are sold from a store shelf, there is considered to be various patterns such as a pattern in which the products are sold from the front side, a pattern in which the products are sold from the furthest side, and a pattern in which the products are sold in a random order. However, there is a tendency depending on characteristics of the products, a structure of the shelf, and customer psychology. Detection of the amount of partial stock on the store shelf is sufficient for recognizing the amount of stock and determining replenishment timing by utilizing the purchase tendency. Inventive step is claimed in terms of the fact that a highly effective store stock detection sensor can be configured with a simple configuration by non-uniformly distributing the detection points from such a viewpoint and performing efficient detection.

The sheet-shaped sensor that is placed on the store shelf and detects the amount of store stock by detecting the number or amount of the products placed thereon may include a detection area on the sheet is divided into a plurality of mutually independent detection sections, and further, each of the detection sections is formed of a plurality of switch groups that are OR-connected to each other. It is possible to estimate the size of a product placed on a section by detecting, in an analog fashion, how many switches are in contact with the product from among the plurality of switch contact points that are OR-connected to each other.

A sheet-shaped sensor that is placed on a store shelf and detects the amount of store stock by detecting the number or amount of the products placed thereon may include a plurality of adjacent sheets are coupled by a wired cable that functions both as communication means and as power supply means and summary means connected to one end is used to detect the amount of stock in units of sheet groups. It is possible to flexibly respond to various installation requirements by changing the number of sheet coupling points as necessary. It is possible to simplify the configuration since it is not necessary to prepare a power source for each sheet.

The sheet group to which the plurality of detection sheets are coupled may include that power distribution to the sheet also functions as a trigger of starting the detection. Power is turned off when no detection is performed, and power consumption can be zero.

The sheet group to which the plurality of detection sheets are coupled is may include that the sheets send signals to each other after the start of the detection to recognize the respective positions and a sheet at the endmost portion sequentially sends detection data to summary means in a bucket relay manner while adding the data. Since the positions relative to the respective sheets (an order of connection) from the summary means can be known, it is not necessary to allocate IDs, for example, to the sheets, and it is possible to simply perform management and to flexibly perform maintenance such as replacement of the sheets, change in the numbers, and replacement at the time of malfunction.

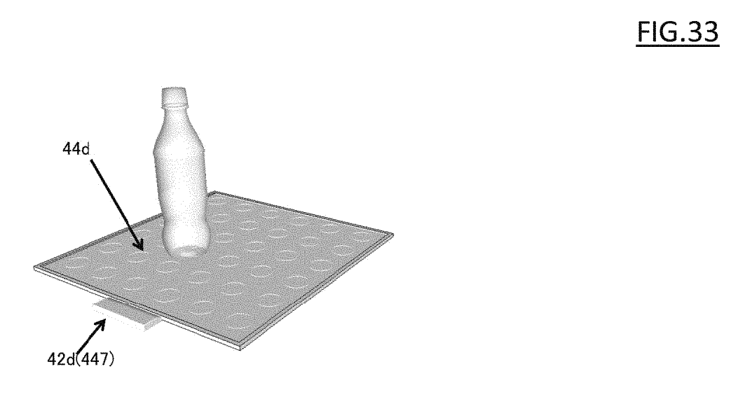

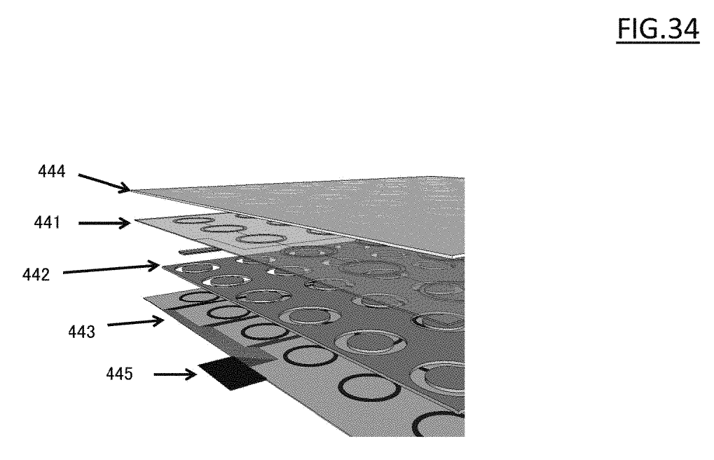

FIG. 33-36 is a detection sheet 44d corresponding to one of the detector 44 in accordance with a feature of the disclosure. A detecting system 100 according to a first example includes detection sheets 44d using membrane switches 401, microcomputer substrates 43d for detecting states of the detection sheets 44d, a cable that connects a set of the plurality of detection sheets 44d and the microcomputer substrates 43d, a computing device that collects detection data sent from the set of the plurality of detection sheets 44d and the microcomputer substrates 43d via the cable and computes a stock-out state, a communication device 42d1 for transferring the computation result of the computing device to another place, a control device that performs overall control of operations of the entire detecting system 100, a power source that supplies power to the entire system, and the like. Among them, the detection sheets 44d using the membrane switches 401 and the microcomputer substrates 43d for detecting states of the detection sheets 44d are always used in the form of pairs, and a pair thereof will be referred to as a stock-out detection sheet. In addition, a set of the computing device, the communication device 42d1, and the control device is used for the plurality of stock-out detection sheets 44d, and the three devices will be collectively referred to as a controller 42d. The power source may be a commercially available power source, a battery, a solar battery, or another energy harvesting means.

Each membrane switch 401 has a three-layer structure, a protect sheet 444 and an electrode connector 445. The first layer (an upper electrode sheet) 441 and the third layer (a lower electrode sheet) 443 include electrodes that are formed by means of screen printing or etching, for example, on resin films of PET or the like. The second layer 442 is disposed so as to be sandwiched between the first layer 441 and the third layer 443 and is made of a resin film or a thick membrane produced by printing.

In the three-layer structure of the membrane switch 401 described herein, the electrodes formed in the first layer 441 and the second layer 442 are disposed so as to inwardly face each other, and a gap is formed between the electrodes by the second layer 442 inserted therebetween. Therefore, the facing electrodes are not in electrical contact with each other due to the gap of the second layer 442 in a state in which the membrane switch 401 is left to stand. Examples of a material used for forming the electrodes include a metal foil, silver paste, carbon paste, and a mixture thereof. In addition, a film with a hotness in a range from about 10 microns to about 100 microns is used as the film, and the width of the gap is about 1 mm at maximum.

In order to detect a state of the electrodes formed on the resin films, wiring from the electrodes to the microcomputer substrate 43d is also formed. The wiring may be formed by using the same material as that used for forming the electrodes.

Once a load is applied to such a membrane switch sheet, the film of the first layer 441 is deformed due to the applied weight, is finally deformed so as to exceed the gap length, and is brought into contact with the facing electrode. Since this forms electrical conduction, appropriate wiring to the facing electrode makes it possible to detect the contact between the electrodes at a portion corresponding to the applied weight. In doing so, it is possible to detect whether or not substances are placed on the stock-out detection sheet.

By appropriately setting an area of the detection sheets 44d and forming the plurality of electrode pairs and the wiring, it is possible to concurrently detect contact states of the plurality of switches on the detection sheets 44d. In doing so, it is possible to detect on which part of the detection sheets 44d substances are placed, and if the size of each placed substance is known, it is possible to recognize the number of the substances.

The states of the plurality of stock-out detection sheets 44d are detected by the microcomputer substrates 43d as described above, and the results are sent to the controller 42d via the cable. The controller 42d uses the computing device to appropriately compute the data sent from the plurality of stock-out detection sheets 44d, and calculates the absolute number of the substances on the sheets in some cases or calculates a rate thereof in other cases, and sends the computation result to another place set in advance by using a communication device 42d1. A series of these operations is harmonically controlled by the control device.

Various destinations of the computation result can be considered. For example, the result may be simply displayed on a display device, such as a lamp or a liquid crystal display, attached to the controller 42d, or the result may be sent to means using a network, such as an e-mail or an HTTP server. At this time, the control device can also serve as a server that manages connection to the network and services.

Now, a specific formation example of each detection sheet according to the first example will be shown in FIG. 33. FIG. 33 is a top view of the sheet of three overlapping layers, and shows that placing an article on the front side of the paper causes an operation of bringing the mutually facing electrodes formed in the two layers in the thickness direction of the paper into contact with each other.

In the detection sheet illustrated in FIG. 33, a plurality of mutually facing electrodes are formed. Hereinafter, the mutually facing electrodes will be expressed as contact points in the following description.

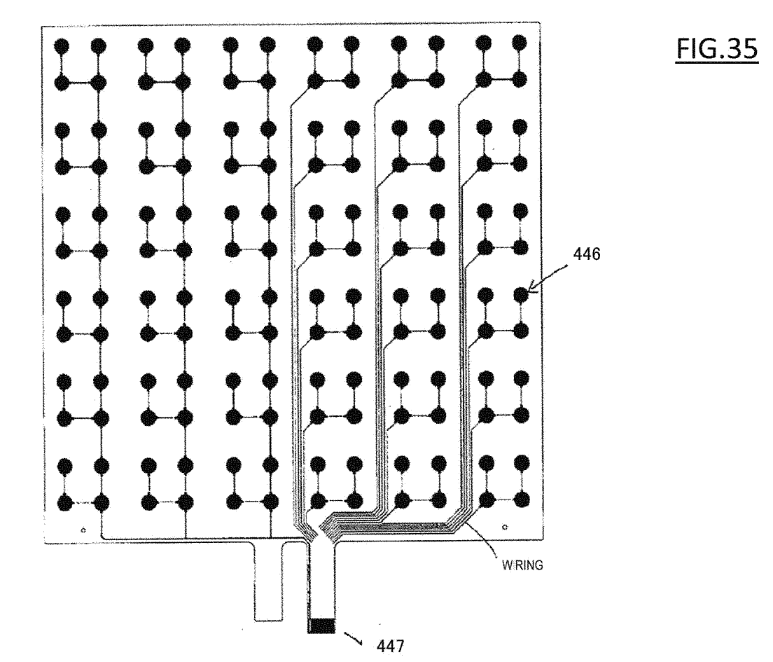

The contact points are illustrated as black circles in FIG. 33. In addition, the plurality of contact points are connected to each other by wiring and are collected at one end of the detection sheet so as to form a connector with the microcomputer substrate 43d. At this time, the plurality of contact points may form some contact point groups. For example, four contact points form a group in FIG. 35 contact point groups are created and collected at the connector though not illustrated in detail. According to the configuration in which the contact points form groups, electrical contact at any contact point in the same group is electrically detected as contact of the group. That is, it is possible to state that all the contact points in a group are OR-connected to each other.

Other typical methods of connecting such a plurality of contact points are known, and a representative example is called matrix connection. Although the matrix connection is not described herein in detail, the matrix connection is an efficient method capable of detecting a large number of contact points with less wiring. It is a matter of course that the detection sheets 44d can be connected to the microcomputer substrates 43d by the matrix connection. However, the matrix connection has a problem that it is not possible to precisely detect the positions and the number of a large number of connecting points that are concurrently brought into contact while it is possible to reduce the number of wirings. Therefore, it is necessary to contrive a configuration in which current back-flow preventing diodes are inserted into the respective contact points, for example, in a case of the inspection detecting system, for example, which is used in a state in which a large number of substances are placed thereon and most of the contact points on the sheets are in contact.

Next, description will be given of operations of the detecting system 100 according to the invention in chronological order.

As described above, it is the control device that performs overall control of a series of operations of the system. First, the control device instructs the plurality of stock-out detection sheets 44d to detect states of the detection sheets 44d and send the data. This will be referred to as a trigger of starting the detection or simply as a trigger. As for a type of the trigger, various means can be employed. Examples thereof include start of power distribution to the stock-out detection sheets 44d and exchange of specific digital signals via the cable. In addition, various cues leading to the trigger can be employed. For example, the operations may be performed at a constant interval by using a timer built into the control device itself, or alternatively, the controller 42d itself may receive the trigger of starting the detection from the outside. The trigger may be signals from various sensors or may be a detection request from the outside via a network.

After receiving the trigger from the controller 42d, the microcomputer substrates 43d respectively connected to the stock-out detection sheets 44d detect states of the detection sheets 44d connected to themselves. Then, the microcomputer substrates 43d send the detected data in a predetermined appropriate format to the controller 42d via the cable. At this time, usage of wireless communication means instead of the cable for sending the data is not prevented.

The data from the plurality of stock-out detection sheets 44d is collected in the controller 42d by the communication device 42d1 and is then sent to the computing device.

The computing device appropriately computes the data and then returns the data to the communication device 42d1, and the communication device 42d1 sends the computation result to a predetermined destination.

The detection sheets 44d according to the first example are configured to be able to be cut in accordance with an installation location. This is one of the features of the invention.

Detailed description thereof will be given with reference to FIG. 35. As for the size of the detection sheet illustrated in FIG. 35, the detection sheet has a square shape with a side of 40 cm, for example.

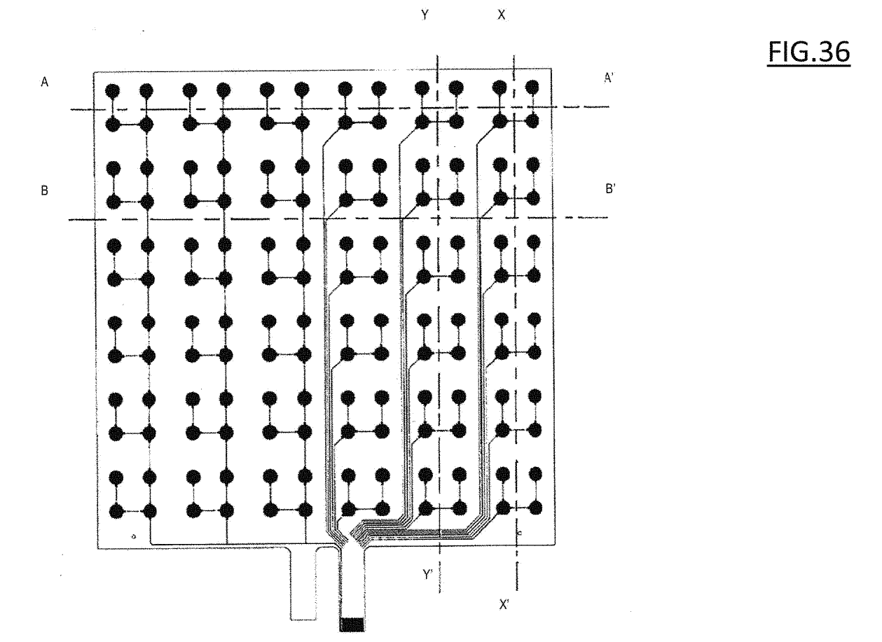

If the sheet is cut along the lines A-A′, B-B′, X-X′, and Y-Y′ illustrated in FIG. 36 for example, all the contact points in the remaining part with a large area, which includes the connecting portion, operate normally without losing any functions. By disposing the contact points and appropriately arranging the wiring as described above, it is possible to appropriately cut the detection sheet in accordance with the size of the installation location.

In addition, each of the electric contact portions of the contact point in the detection sheet illustrated in FIGS. 35 and 36 has a circular shape with a diameter of 4 mm. It is obvious, of course, that the shape and the size should be appropriately set in accordance with the size and the weight of the substance to be detected. In the case of the circular shape, for example, the diameter may range from about 2 mm to about 20 mm. The shape may be a rectangular shape or a linear shape. In addition, the contact points formed in a single detection sheet do not necessarily have the same shape and the same size, and various combinations can be employed.

Furthermore, the contact points/contact point groups in the detection sheet illustrated in FIGS. 35 and 36 are uniformly disposed and distributed, and in the example in which four contact points are regarded as one group as described above, the four contact points are disposed at positions corresponding to vertices of the square, respectively. As for the interval between groups, each of which is configured of four contact points, the interval between intersecting points of diagonal lines of the aforementioned squares is 65 mm. This is because commercially available 500 ml PET bottles are assumed to be placed on the detection sheets 44d in the first example. As described above, the number, the disposition, the density, and the density distribution of the contact points formed in a single sheet, and in a case in which contact point groups are formed, the number of contact points included in one group, an interval between the groups, and the like should be optimally set respectively, depending on the type, the shape, and the weight of substances to be placed on the detection sheet.

If the number of the contact points is sufficiently large and disposition density is sufficiently high with respect to the shape of the bottom surfaces and the bottom area of the substances to be placed on the detection sheet, and as a smaller number of contact points are included in one contact point group, to describe in an extreme manner, as a configuration of separately detecting all the contact points is approached, it becomes possible to more precisely detect the shape of the bottom surfaces of the substances placed thereon by detecting the states of the contact points in the detection sheet. This means that employment of such a configuration of the contact points enables identification of two substances, for example, based on a difference in shapes of the bottom surfaces.

Although the aforementioned disposition and configuration of the contact points enables detection of the shape of the bottom surfaces of the substances placed thereon, it is possible to detect the bottom area of each substance on the detection sheet with another configuration. The detection sheet used in the example is typically referred to as a membrane switch 401 as described above. Contact points in the membrane switch 401 are also formed of silver paste or carbon paste as described above in some cases. Such a material typically has higher resistivity than that of metal foil, and it is known that electric resistance in a case in which the contact points formed of such a material is brought into electric contact reaches several hundreds of □ to several k□. In the example, four contact points form a group with the aforementioned OR configuration. The OR configuration of the four contact points means that the four contact points are connected in parallel, in other words. If it is assumed that the resistance of each of the four contact points of the switch is 1 k□, in a case in which one of the four contact points is in contact, a resistance of 1 k□ is apparently connected to the end of the wiring when viewed from the detection side, namely the side of the microcomputer substrate 43d. In a case in which two contact points are in contact, contact point resistances of 1 k□ are electrically connected in parallel, and the resistance when viewed from the detection side is apparently 500 □. If three or four contact points are in contact in the same manner, a resistance of 333 □ or 250 □ is apparently connected, respectively.

A contact point of the microcomputer substrate 43d that performs the detection typically includes a port for digital input and a port for analog input. The digital input port has only two states, namely HI and LOW, which are determined depending on whether a voltage applied to the digital port is higher or lower than a reference voltage. In contrast, the analog port can detect the value in detailed steps of 1024 levels, for example, and can identify 3 V and 3.2 V as different values, for example.

Now, a case will be considered in which the switch group with the aforementioned configuration of the OR connection is connected to the digital port. By configuring a circuit such that a voltage to be input to the digital port changes beyond the reference voltage, which determines HI/LOW, if any one of the four contact points forming a group is in contact, it is possible to detect that any of the contact points in the group is in contact, that is, it is possible to detect, based on placement of a substance on at least one of the four contact points, that the contact point is in contact. Even if any two or more of the four contact points forming the group are in contact at this time, no change occurs in the state of the digital port since at least any of them has already changed from HI to LOW or vice versa at the timing when one contact point was brought into contact. That is, it is possible to state that the digital port cannot identify and detect how many contact points from among the contact points forming the switch group are in the contact state.

Next, a case will be considered in which the switch group with the aforementioned configuration of the OR connection is connected to the analog port. The analog port can identify the voltage in two or more levels rather than HI/LOW as described above, and more typically, the analog port can finely identify the voltage in 128 or more levels. In contrast, in the case of the example in which four contact points, for example, form a group as described above, the resistance value of a specific contact point group when viewed from the detection side changes to an infinite value (no contact), 1 k□ (one contact point is in contact), 500 □ (two contact points are in contact), 333 □ (three contact points are in contact), and 250 □ (four contact points are in contact) depending on the number of contact points in contact. The change can be represented as a change in the voltage in accordance with Ohm's law by appropriately configuring the circuit, and it is possible to detect how many contact points in one OR-connected contact point group are in contact, by detecting the change in the voltage by the analog port. That is, this means that even if a large number of contact point groups are formed of groups of a plurality of contact points, it is possible to recognize how many contact points on the detection sheet are in contact with a specific substance, that is, it is possible to estimate how large the bottom area of the substance is.

Although only one contact point group was described hitherto for simplification, the detection can be made by appropriately computing data between contact point groups in a plurality of contact point groups, or for a substance with such a bottom area that extends across a plurality of contact point groups.

Furthermore, collective detection of how many contact points on the detection sheet are in contact means that it is possible to estimate information indicating the amount of substances on the detection sheet based on the bottom area thereof, and it is possible to state that a substantially sufficient function can be achieved for the purpose of stock-out detection.

In another example, specific and detailed description will be given of an operation flow chart of the system.

The system is configured of two or more stock-out detection sheets 44d and the controller 42d. However, description will be given here on the assumption that the number of the stock-out detection sheets 44d is two for simplification, and the stock-out detection sheets 44d will be referred to as a stock-out detection sheet 44da (switch array sheets 44da) and a stock-out detection switch array sheet 44db (switch array sheets 44db), respectively, or as a switch array sheet 44da and a switch array sheet 44db for further simplification for identifying the respective stock-out detection sheets 44d.

In the second example, the controller 42d and the switch array sheets (detection sheets) 44da and 44db are connected to each other in serial by a wired cable. That is, the controller 42d is connected to the switch array sheet 44da, and the switch array sheet 44da is connected to the controller 42d and the switch array sheets 44db, respectively.

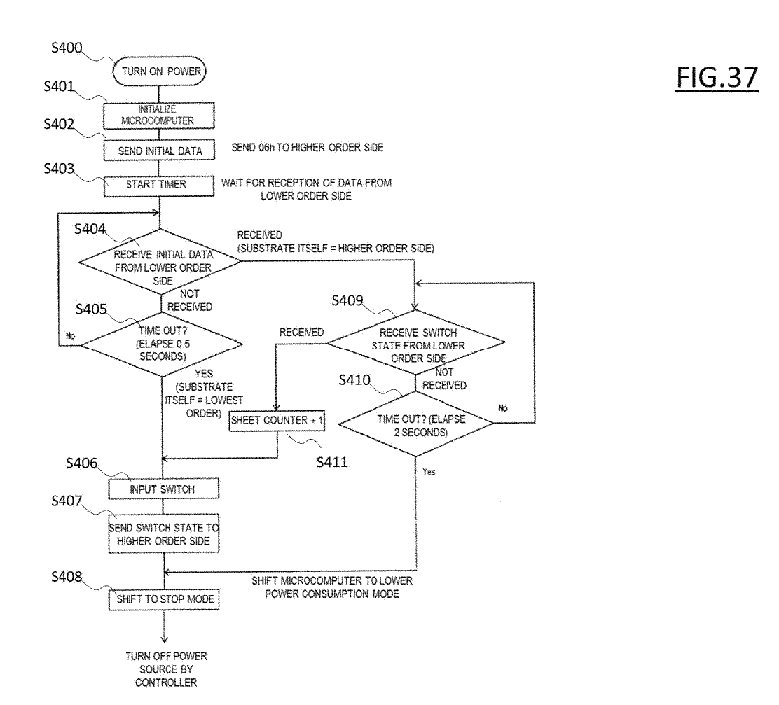

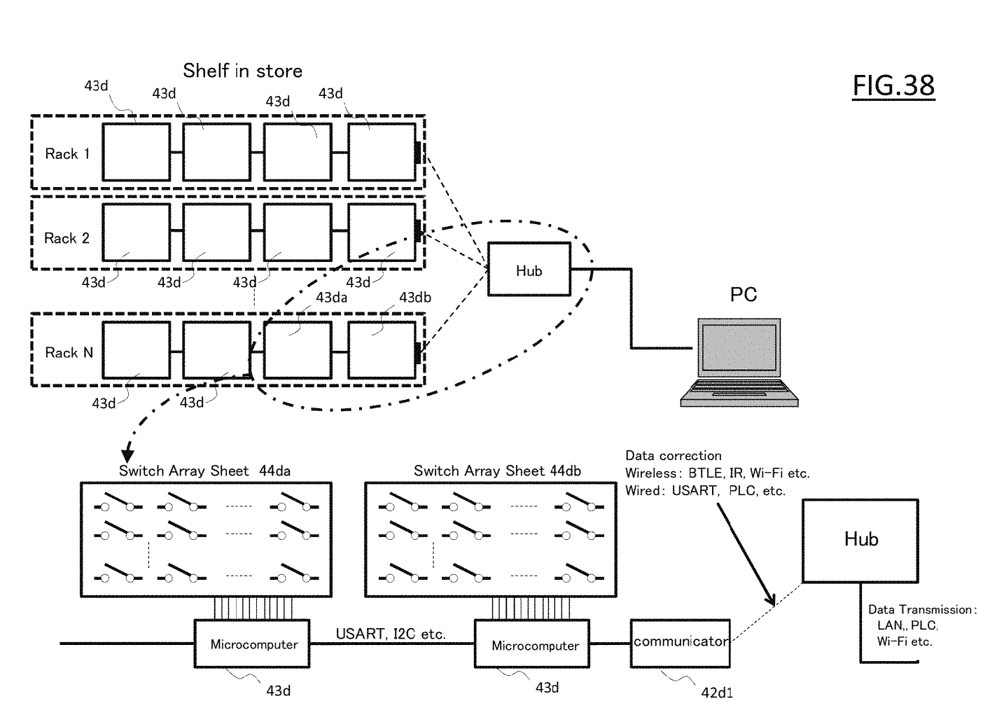

Hereinafter, detailed description will be given of operations of the detecting system 100 with the configuration with reference to the flowchart illustrated in FIG. 37 with reference to FIG. 38. FIG. 38 is one example of the detecting system 100.

First, an outline of spirit based on which the flowchart will be described. First, the detecting system 100 is designed on the assumption that the system is used on a store shelf placed in a typical shop area in a store. It is a matter of course that this is an example, and examples of a target to which the system is applied can widely include a space for stock in a back room of a store or a location such as a warehouse, a chemical closet, or an equipment cabinet where substances are moved into or out of a storing space such as a shelf Description will be given herein of an example of a store shelf in a store.

On the store shelf at a store, the number/amount of products placed on the shelf changes in accordance with sales. It is the detecting system 100 that detects the change, detects whether the amount of products is less than a separately set reference amount, and performs some operations.

In addition to changing products displayed on a store shelf at a store depending on seasons, configurations such as disposition of shelves and the number of levels in each shelf are also often changed. In order to facilitate usage of the detecting system 100 and cause the detecting system 100 to stably operate under such circumstances, it is necessary to contrive a special configuration.

For example, it is considered that a case in which all products are displayed on a single stock-out detection sheet and then it is determined to use two sheets in response to a change in products or a case in which two stock-out detection sheets 44d are removed or re-disposed at another location from a shelf to which five stock-out detection sheets 44d had been connected until then occurs. That is, it is necessary to freely change the configuration and the disposition of the stock-out detection sheets 44d in order to secure usability at the store.

If the plurality of stock-out detection sheets 44d respectively have IDs, for example, and positions of shelves and products are associated with each other based on the IDs, it is necessary to reset the association of the IDs and the positions of the stock-out detection sheets 44d and the products every time the configuration of the stock-out detection sheets 44d is changed. This causes nothing other than complication and should be avoided since this may increase a burden on busy store business.

The flowchart of was contrived in view of such circumstances for the purpose of securing system operations without any identification by application of IDs to the plurality of stock-out detection sheets 44d and enabling free configuration change of the stock-out detection sheets 44d.

The flowchart will be shown in FIG. 37. Features of the detecting system 100 that operates in accordance with the flowchart illustrated in FIG. 37 are as follows.

First, the respective stock-out detection sheets 44d do not have individual IDs and are not distinguishable. Therefore, replacement of the arbitrary two sheets does not affect operations.

In addition, the number of the stock-out detection sheets 44d connected to one controller 42d is not logically limited and can be freely changed. Although the upper limit of the connection is substantially considered to be several tens of stock-out detection sheets 44d in consideration of reasonable electric properties, this is not an essential limit due to the flowchart.

According to the detecting system 100, the sheets are identified based only on the positions thereof as described above. The positions described herein can also be expressed as orders of connection from the controller 42d as a base point. Therefore, it is only necessary for an operator at a store to know the connection orders of the stock-out detection sheets 44d, and the disposition of the stock-out detection sheets 44d on the shelf in the order causes self-association of the product positions and the sheet positions on the shelf.

Data from the respective stock-out detection sheets 44d is transferred in an organized order in a bucket relay manner from the furthest sheet from the controller 42d to the controller 42d. In doing so, the controller 42d can recognize the number of stock-out detection sheets 44d connected to the controller 42d itself by checking the amount of data sent. In addition, since the series of data is arranged in the organized order from the stock-out detection sheet at the furthest end, disposition of the data and disposition of the stock-out detection sheets 44d are automatically associated. This means that it is possible to know a stock-out state by positional information that “the products on the rightmost side on the second level in a certain shelf are likely to get exhausted”, and it is possible to optimally replenish the products based on the information about the shelf position since an ordinary operator knows the position of the products in the store.

Here, the stock-out detection sheet at the furthest end from the controller 42d should be able to correctly recognize that the stock-out detection sheet itself is located at the furthest end as an essential condition in order to perform such an operation. For the detecting system 100, the role of the sheet at the furthest end is significantly important.

Hereinafter, description will be given of the flowchart illustrated in FIG. 37 based on an example of the configuration according to the second example, that is, the system that is configured of the one controller 42d and the inspection detecting sheets A and B.

As described above, the sheet at the furthest end in the detecting system 100 according to the second example is the switch array sheets 44db. That is, the controller 42d, the switch array sheet 44da, and the switch array sheets 44db are connected in this order by the cable.

Incidentally, if the power is turned on (Step S400), the system starts the operation, and the controller 42d provides a trigger to the stock-out detection sheets 44d. The trigger in the example is an operation of turning on the power for the stock-out detection sheets 44d.

At the timing at which power distribution to the stock-out detection sheets 44d is established, there is no method for both the sheets A and B to know to which positions on the system the sheets A and B themselves are connected, in other words, whether the sheets A or B itself is the sheet at the furthest end that plays the important role. Thus, the respective stock-out detection sheets 44d send signals for checking the positions thereof to each other. In the example, a rule is set for a connecting direction of the stock-out detection sheets 44d, namely a data transfer direction. That is, a direction of the bucket relay is determined. Here, it is assumed that the direction in which the data is sent is upstream and the opposite direction is downstream for clearly stating the directions. It is additionally noted that the rule is set for simply describing the example and the flowchart itself can be applied with no problem even if the directions are not set, and further, even if loop connection is performed.

Returning to the description, the respective sheets send a specific signal (Step S402) to the upstream after the power distribution to the stock-out detection sheets 44d is established. In the example, the signal is 06h.

At this time, the switch array sheet 44da receives the signal from the switch array sheets 44db on the downstream side (Step S404) while the switch array sheets 44db itself does not receive the signal from the downstream side though the switch array sheets 44db sends the signal to the upstream side since the switch array sheets 44db is the sheet at the furthest end. That is, the sheet, the switch array sheets 44db in the example, knows that the sheet itself is located at the furthest end based on the fact that the sheet cannot receive the signal from the downstream side after the elapse of a predetermined period of time after the power distribution.

The sheet which has recognized that the sheet itself is located at the furthest end detects a state of a next detection sheet connected to the sheet itself and organizes the state as data. Then, the sheet sends the data to the upstream (Step S407).

In contrast, the switch array sheet 44da which has recognized that the sheet itself is not located at the furthest end by receiving the signal from the downstream side, namely from the switch array sheets 44db just waits for the data sent from the downstream side. If no failure occurs in the operation, the data is sent from the downstream side in a short time (Step S409). At this time, the data sent to the switch array sheet 44da is only data of only one sheet, namely the switch array sheets 44db connected on the downstream side in the example.

The switch array sheet 44da which has received the data from the downstream side, namely from the switch array sheets 44db detects a state of a detection sheet connected to the switch array sheet 44da itself, organizes the state as data, and adds the data to the data from the switch array sheets 44db. At this time, to which part of the data from the switch array sheets 44db the data of the switch array sheet 44da is to be added is determined in advance by a program, and the addition position is standardized in the entire system. The switch array sheet 44da which has added the data of itself sends data of the two sheets to a further upstream. Then, the data of the two stock-out detection sheets 44d is sent to the controller 42d located on the upstream side of the switch array sheet 44da and is computed therein.

Although the description of the example was given on the assumption that the number of the stock-out detection sheets 44d was two for simplification, the number of the sheets does not logically have an upper limit. An important point for the operations of the system is that the sheet at the furthest end recognizes that the sheet itself is located at the furthest end.

Although it is a matter of course that the amount of data to be transferred increases in proportion to an increase in the number of the stock-out detection sheets 44d, the speed of data communication is typically high enough to transfer data of the detecting system 100, and if connection of about 50 sheets is assumed, for example, time required for transferring the data can be equal to or less than 1 second.

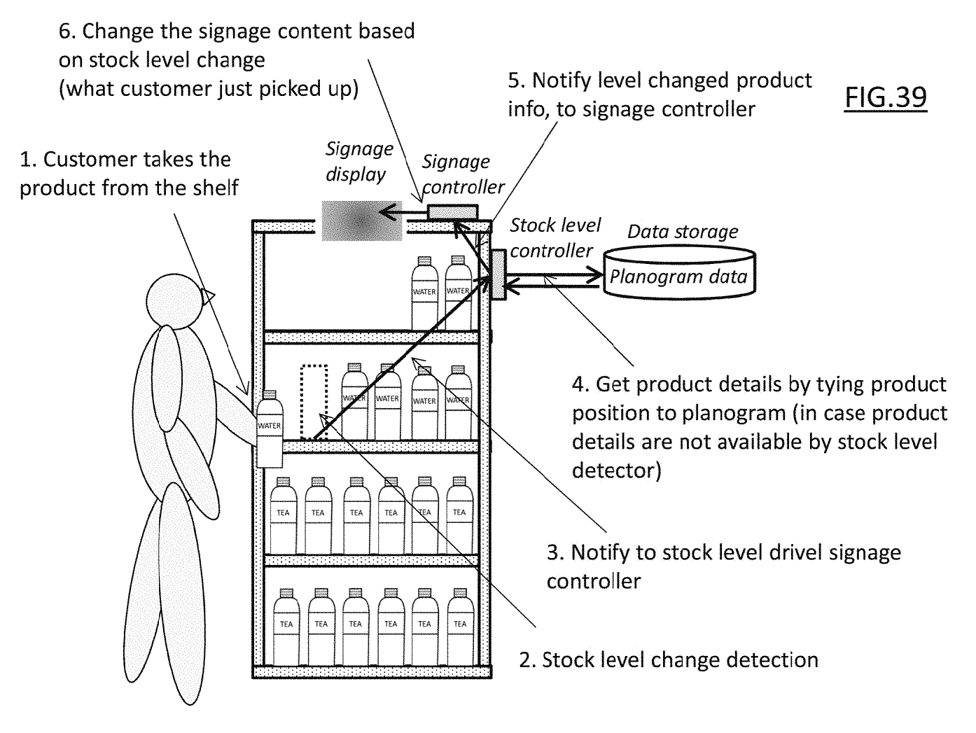

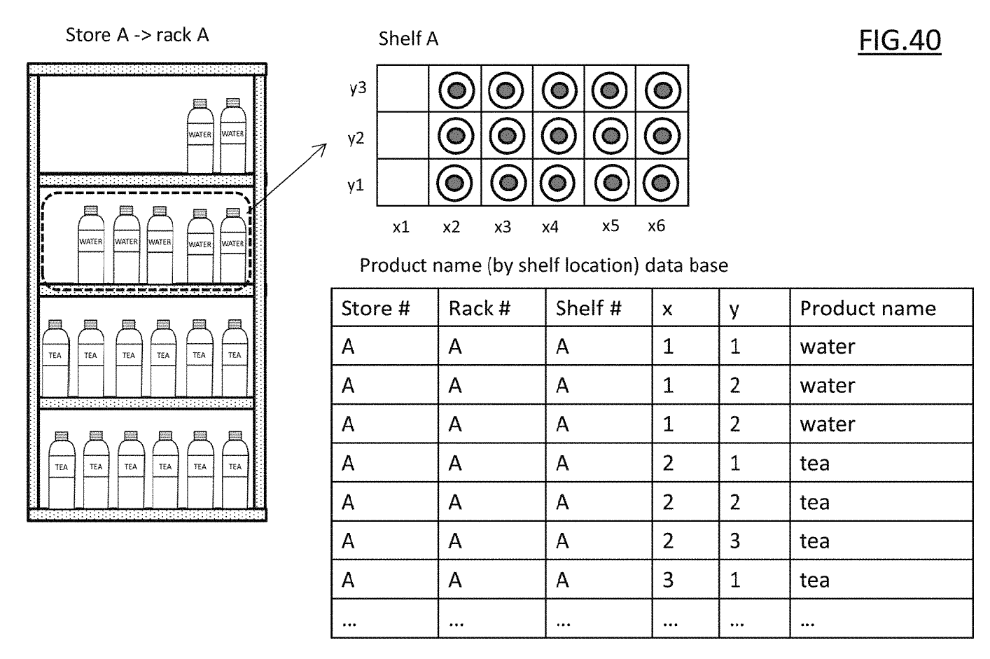

FIG. 39 is one example of the detecting system 100 in accordance with a feature of the disclosure. FIG. 40 is an image including planogram and stock status in accordance with a feature of the disclosure. The system includes a display (signage display), may correspond to the display 30, a display controller (signage controller), may correspond to at least part of the management device 30, a stock detector 44d , a stock status controller (stock level detector), may correspond to at least part of the management device 30, and a data storage (data storage), may correspond to the memory 34 of the management device 30 or the stock management memory 503, that has shelf display information (planogram data). The display controller and the stock status controller include processors and memories or the like that store programs to be executed by the processors. The system detects a stock status of products disposed in a product disposition location such as a store shelf and changes content on the corresponding display (signage display) in accordance with the detected stock status (see FIG. 39). The change of the content relates to the products that have caused the variation in the stock status and promotes purchase of customers who have purchased the corresponding products. Examples thereof include content of a group of one or more products that are often purchased with a product A when the product A is purchased, content in relation to how to use the product A, content in relation to bulk purchase of the product A for good deals, and a discount applied to members. In the case of displaying the content in relation to bulk purchase, the display may show a location where the bulk purchase is available by using a store map or the like. Since a location where drinks are sold one by one differs from a location for bulk purchase thereof in a large-scaled retail store, for example, such store map information helps customers who desire the bulk purchase.

As a method of detecting the aforementioned variations in the stock status, various methods such as a pressure sensor, a weight sensor, an infrared sensor, an RFID sensor, and image analysis through a camera can be applied. That is, the stock detector may be configured of a pressure sensor, a weight sensor, an infrared sensor, an RFID sensor, or a camera. In addition, the stock status is detected by such a sensor. That is, such a sensor is used to detect whether products are present at each physical position. Furthermore, the data storage has a database that indicates what kind of products are present at each physical position in written product disposition such as a store shelf. It is possible to match corresponding products by using the database and the position where the stock status has been changed (FIG. 39). In addition, it is possible to use a planogram that defines product disposition positions on the store shelf in order to make the product database. Moreover, photos of disposed products can be analyzed for product recognition, and data can be obtained.

It is desirable that the display that displays promotion content in accordance with variations in the stock status as described above is installed at a position near the picked up product, and as in FIG. 39, for example, the display is attached to the store shelf in which the products are displayed. Examples of the attachment position are an upper portion and a side portion of the store shelf. In addition, the position of the display is not limited to the store shelf, may be installed at another location, or may be a mobile terminal.

Here, a brief description will be given of a process until content displayed on the display is changed. (1) First, if a customer picks up a water bottle from a store shelf, (2) then the stock detector detects that there is no water bottle. Furthermore, the stock detector can detect the position from which the water bottle has been picked up. In FIG. 39, the stock detector detects that there is no water bottle in the second row from the left on the second shelf from the upper side. (3) Then, the stock detector informs the stock status controller of the stock-out position of the water bottle. (4) The stock status controller accesses planogram data stored in the data storage and matches the planogram data with the received stock-out position, thereby recognizing that the stock-out products are water bottles. In addition, the data storage may be attached to the store shelf, or may be installed at a different location from the store shelf and be connected to the stock status controller via a wired network or a wireless network. (5) Furthermore, the stock status controller informs the display controller of the fact that the customer has picked up the water bottle. (6) The display controller selects content in relation to the water bottle from among a plurality of content items that can be displayed and displays (changes) the selected content on the display. While the display is displaying the selected content, the display may not change the content to be displayed and maintain the content.

Furthermore, if promotion content in accordance with the variation in the stock status is content on the assumption of the fact that the product has been picked up, it is desirable to display the content after the product has surely been picked up. That is, it is desirable not to display temporal or slight change in the stock status, which is caused by the action of touching the product or slightly lifting the product, for example, by the customer who has not yet decided to pick up the product. For example, the system may display the promotion content in a case where a predetermined period of time (T0) elapses, or in a case where a predetermined amount of variations in the stock status (S0) is exceeded to fix the variations in the stock status. The predetermined period of time T0 can be set to 1 second or the like in consideration of typical purchase actions of customers, for example. In addition, the predetermined amount of variations in the stock status S0 can be set to 1% or the like. In a case in which the promotion content is content that is not based on the assumption of the picking-up of the product, no problem occurs if T0 and S0 as described above are not applied.

Furthermore, as for the content display in accordance with variations in the stock status, it is possible to display the promotion content before the customer picks up the product and leaves the place, by performing the display within a predetermined period of time (T1) after the corresponding variation in the stock status. The predetermined period of time T1 can be set to 3 seconds or the like in consideration of typical purchase actions of customers, for example.

Furthermore, there is also a case in which a customer purchases a plurality of the same products, and in particular, the customer moves the products one by one from a store shelf to a shopping basket in many cases. If the content is displayed again every time the customer picks up the product from the store shelf, a promotion effect is considered to be degraded due to discontinuation of the display of the content, for example. However, in order to prevent such degradation of the effect, it is possible to apply a configuration in which the content display is not performed again when the variation in the stock status of the same product occurs again within a predetermined period of time (T2). The predetermined period of time T2 can be set to 3 seconds or the like in consideration of typical purchase actions of customers. In addition, it is also possible to dynamically set the interval not to perform the side display as long as there is any customer near the store shelf For person detection performed here, person detection based on video analysis using a camera movie or smart phone detection by using WIFI, Bluetooth, or the like can be used, for example.

Furthermore, it is also possible to consider two or more types of products are disposed on one store shelf. In such a case, one display needs to respond to variations in stock statuses of the two or more types of products. By forming a database of and providing cooperation between disposition positions of products as described above, it is possible to easily identify products that have caused a variation in the stock status and to display different content for different products. In the case in which one display handles a plurality of types of products as described above, different customers may pick up different products A1 and A2 at the same time. In such a case, a product with the highest priority is selected from among the products that have experienced variations in the stock statuses, and content corresponding to the product is displayed. In relation to how to apply priority herein, the priority can be applied depending on promotion effects in the past, incentive for display of the content from product suppliers, campaigns currently underway, product inventory statuses, or the like. In addition, it is also possible to select a product by a round-robin scheme or a random scheme. The expression “at the same time” herein means a case in which picking-up of the first product and picking-up of the second product occur within time T3. In addition, T3 can be set to 1 second, for example.

Furthermore, there is also a case in which variations in a product stock status may be caused by a person in charge of replenishment or display of the products such as a store staff member or a merchandizer as well as the customer. It is not desirable to display content on the display in such a case. Therefore, in order to handle such a case, it is possible to employ a configuration of not displaying the content in a case in which a pattern of a variation in a stock status is similar to a replenishment pattern or a redisplay pattern by a specific value or more. Examples of the replenishment pattern include an increase in the stock status, and examples of the redisplay pattern include a pattern in which no change occurs in the stock status or the stock status changes by less than a specific value, such as 1% and only a position of a product changes.

By combining the system with a person tracking system, it is also possible to track a customer who has picked up a product and to display promotion content by using a display terminal near a second product when the customer reaches a position near the second product group as a target of the promotion. For person detection performed here, person tracking based on video analysis using a camera movie or smart phone detection by using WIFI, Bluetooth, or the like can be used, for example.

By applying the aforementioned stock status detection method to the second product, it is possible to know whether the customer who has purchased the product A also purchases the product B from a viewpoint of measuring customer purchase actions and from a viewpoint of measuring an effect of the displayed content.

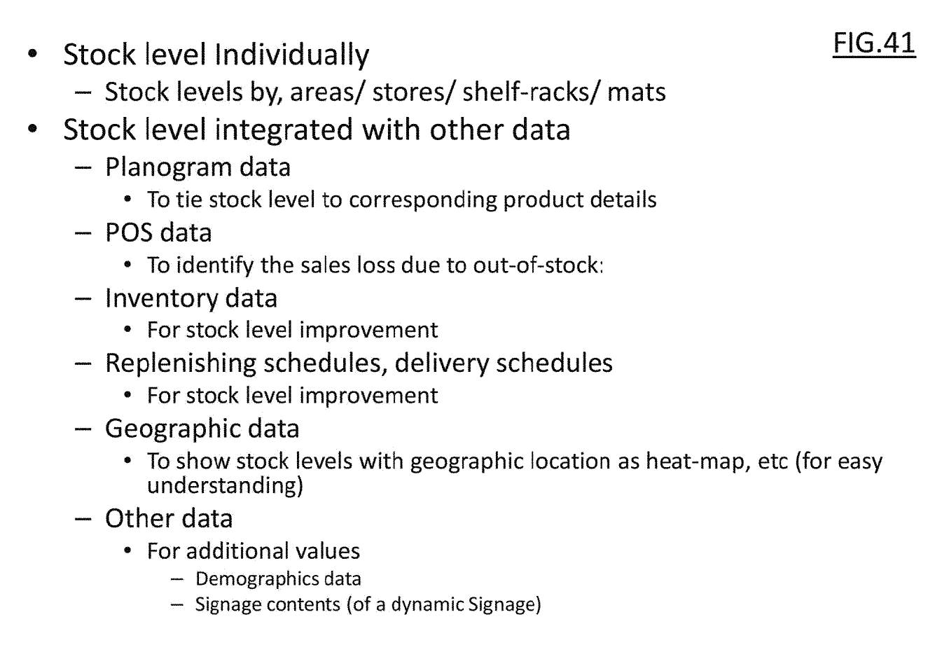

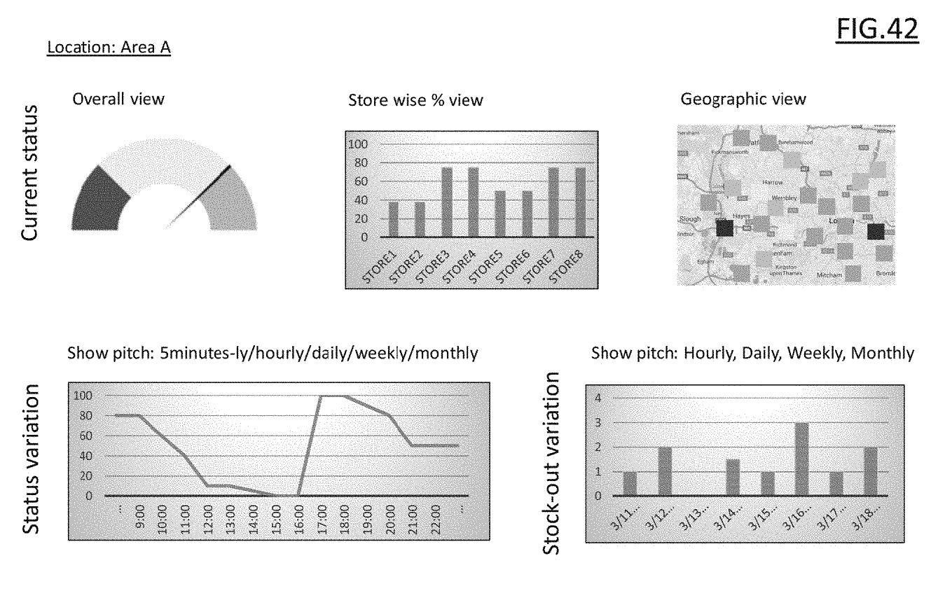

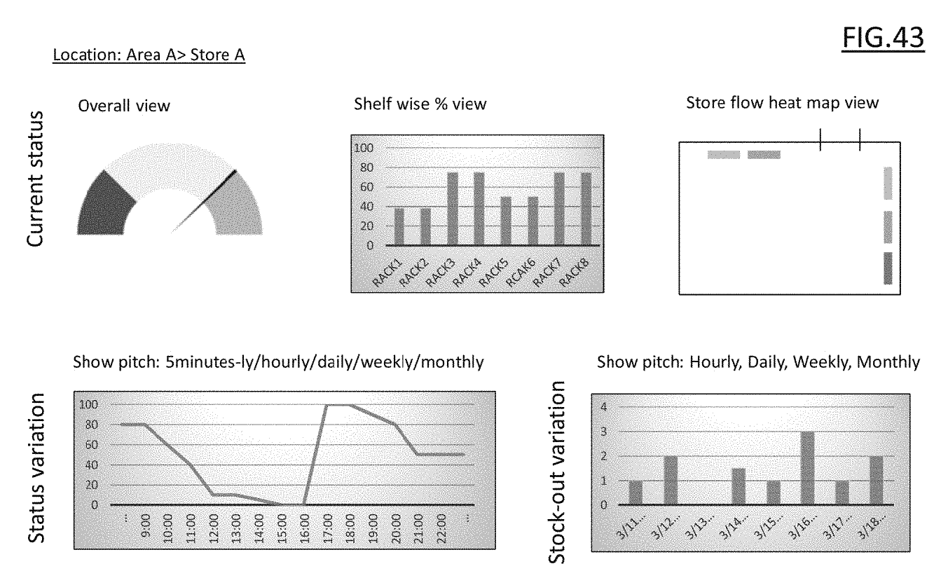

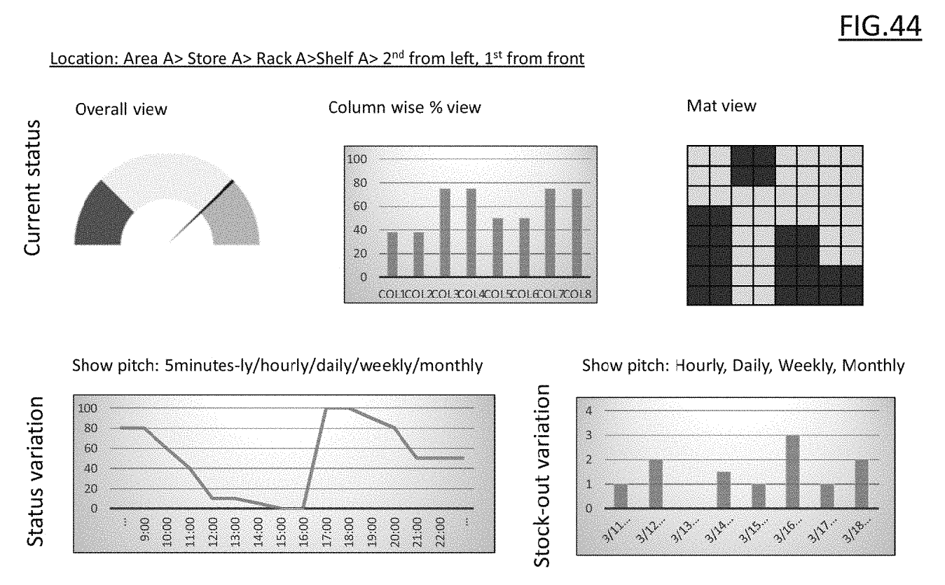

In addition, FIG. 41 shows data list stored in the database. FIGS. 42 to 44 show display examples of stock statuses (stock levels). FIG. 42 shows stock statuses in an area including a plurality of stores. The stock statuses at the respective stores are distinguished with colors. FIG. 43 shows stock statues at a store including a plurality of store shelves. FIG. 44 shows stock statuses in one shelf.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

1. A stock management method comprising:
detecting status of stock displayed on stocking place like a shelf, and
transmitting information based on the status of stock to deliverer having the stock a predefined receiver.

2. The apparatus according to claim 1, wherein:
the method detecting status of stock, uses one or a combination of, wireless communication such as RFID where the communication status is changed by the material of product that is to be detected, or weight sensors which detects the weight of the products, or image processing where the product images are captured by a cameras.

3. The apparatus according to claim 2, wherein:
the wireless communication used in the method detecting status of stock, has a characteristic that the communication is interfered or blocked by the material of the product that is to be detected, and the wireless reader and the wireless tag is placed in such a way that the product that is to be detected makes its position in between the tag and the reader, and the existence of the product is detected in such a manner that the product is detected exit when the tag can be read by the reader, and the product is detected not exit or un-determined when the tag cannot be read by the reader.

4. The apparatus according to claim 2, wherein:
the wireless reader and the tag be one or more wireless reader(s) and one or more wireless tag(s) placed in such a way, up-side and down-side of the product, left side and right side of the product, upper-left/upper-back corner and lower-right/lower-front corner, or vise-versa of any of those patterns.

5. The apparatus according to claim 2, wherein:
the wireless reader and the tag be one or more wireless reader(s) and one or more wireless tags(s) placed in vertically, where the product become a multiple of vertically stacked products and the status of stock can be detected.

6. The apparatus according to claim 2, wherein:
the wireless communication used in the method detecting status of stock, uses a list of tag IDs and product IDs or names to identify the stock.

7. The apparatus according to claim 2, wherein:
the wireless communication used in the method detecting status of stock, further associated with a method where the tag IDs are dynamically written using a wireless writer based on the product ID or information placed for detection.

8. The apparatus according to claim 2, wherein:
the wireless communication used in the method detecting status of stock, further associated with a method where the detection accuracy degrading caused by the covering happen by the products exist close the target product, is improved using product size (height, width, depth), product-to-product distance, horizontal angle of shelf floor, distance between wireless reader and the product, distance between the wireless tag and the product.

9. The apparatus according to claim 2, wherein:
the wireless communication used in the method detecting status of stock, further associated with a method where the detection accuracy degrading caused by the covering happen by the products exist close the target product, is improved using, the detection results by the other wireless readers exist close.

10. The apparatus according to claim 1, wherein:
the predefined receiver be one or a combination of an alert system, a second stock management system, a delivery management system, a sales management system (or POS), a price management system, a promotion management system, an advertisement management system or a staff management system.

11. The apparatus according to claim 1, wherein:
the transmitting content be one or a combination of item wise current stock amount, stock change ratio, selling out prediction time, expected delivery time, selling out prevention suggestions.

12. The apparatus according to claim 11, wherein:
the item wise current stock amount be the remaining number of items of each product, remaining portion of percentage of each product, stock change ratio be the decrease of each product over given amount of time, selling out prediction time be the estimated selling out time calculated based on the stock change ratio, expected delivery time be the estimated delivery time that can prevent the selling out such as a time that is behind a predefined time of selling out time, selling out prevention suggestions be sales promotion activities of similar other products to prevent selling out based one or more of stock amount, stock change ratio, or selling out prediction time information.

13. The apparatus according to claim 11, wherein:
the information from one or a combination of a second stock management system, a delivery management system, a sales management system (or POS), a price management system, a promotion management system, an advertisement management system or a staff management system is used to calculate any of item wise current stock amount, stock change ratio, selling out prediction time, expected delivery time, selling out prevention suggestions.

14. The apparatus according to claim 1, wherein:
the information be transmitted at predefined intervals, or a timing calculated based on one or a combination of item wise current stock amount, stock change ratio, selling out prediction time, expected delivery time.

15. The apparatus according to claim 2, wherein:
the positioning of optimized for the number of readers and tags and for their installing positions in the shelf, based on one or a combination of product size (height, width, depth), product-to-product distance, the horizontal angle of shelf floor, the height, depth and width of shelf.

16. The apparatus according to claim 1, wherein:
the power is supplied through one or a combination of indoor solar panels, batteries, wired power supply, wireless power supply

17. The apparatus according to claim 1, wherein:
the information be transmitted using in-house wired network such as LAN or wireless network such as Wi-Fi or cellular network such as 3G or 4G

18. The apparatus according to claim 1, wherein:
the transmitting content further associated with an optimal delivery route for multiple stores close by including this store, and this optimal delivery route being calculated based on one or a combination of item wise current stock amount, stock change ratio, selling out prediction time, expected delivery time gathered from the directly from the stores close by or from a separate server.

19. The apparatus according to claim 1, wherein:
the transmitting content further associated with an optimal delivery schedule for multiple stores close by including this store, and this optimal delivery schedule being calculated based on one or a combination of item wise current stock amount, stock change ratio, selling out prediction time, expected delivery time gathered from the directly from the stores close by or from a separate server, and based on weather information, special event information around, and the store's sales promotion event information gathered from another separate server.

20. The apparatus according to claim 1, wherein:
the transmitting content further associated with sales promotion suggestions based on one or a combination of item wise current stock amount, stock change ratio, selling out prediction time, expected delivery time gathered from the directly from the stores close by or from a separate server, and based on population information, demographics information, information of facilities like schools, hospitals or companies, road and traffic information gathered from another separate server.

21-24. (canceled)
